(19) United States
(12) Patent Application Publication
(10) Pub. No.: US 2026/0066785 A1
(43) Pub. Date: Mar. 5, 2026

(54) POWER SUPPLY CONTROL APPARATUS AND POWER SUPPLY SYSTEM

(71) Applicant: ROHM Co., LTD., Kyoto (JP)

(72) Inventor: Hiroaki Asazu, Kyoto (JP)

(73) Assignee: ROHM Co., LTD., Kyoto (JP)

(21) Appl. No.: 19/301,650

(22) Filed: Aug. 15, 2025

(30) Foreign Application Priority Data
Aug. 28, 2024 (JP) 2024-146252

(51) Int. Cl. H02M 3/157; H02M 1/00; H02M 1/34; H02M 1/36; H02M 3/158

(52) U.S. Cl. CPC H02M 3/157; H02M 1/0009; H02M 1/0025; H02M 1/344; H02M 1/36; H02M 3/158

(57) ABSTRACT

Provided is a power supply control apparatus including an output stage provided between an input terminal to which an input voltage is applied and an output terminal to which an output voltage is applied and generating the output voltage from the input voltage. The power supply control apparatus includes a stabilization control circuit causing the output voltage to stabilize to a target voltage by controlling a state of the output stage according to a feedback voltage corresponding to the output voltage, a parameter storage circuit storing a plurality of internal parameters for defining a temperature characteristic of the stabilization control circuit, a communication circuit receiving a command signal from an external apparatus outside the power supply control apparatus, and a setting circuit setting the temperature characteristic of the stabilization control circuit by setting any one of the plurality of internal parameters to valid on the basis of the command signal.

### PRIORITY

The present disclosure contains subject matters related to that disclosed in Japanese Priority Patent Application JP 2024-146252 filed in the Japan Patent Office on Aug. 28, 2024, the entire content of which is hereby incorporated by reference.

### BACKGROUND

The present disclosure pertains to a power supply control apparatus and a power supply system.

A power supply control apparatus for controlling operation by a power supply apparatus that generates an output voltage from an input voltage is provided in the power supply apparatus (for example, refer to Japanese Patent Laid-Open No. 2020-89043 described below).

### BRIEF DESCRIPTION OF THE DRAWINGS

FIG. 1 is an overall block diagram of a system according to an embodiment of the present disclosure;

FIG. 2 is an external perspective view of a power supply control apparatus according to the embodiment of the present disclosure;

FIG. 3 is a view that illustrates an example of a configuration of a power supply apparatus, according to the embodiment of the present disclosure;

FIG. 4 is a view that illustrates a stabilization control circuit and peripheral circuits therearound, in the power supply apparatus, according to the embodiment of the present disclosure;

FIG. 5 is a waveform chart of several signals pertaining to operation by the stabilization control circuit, according to the embodiment of the present disclosure;

FIG. 6 is a view that illustrates a situation in which a plurality of internal parameters are stored in a parameter storage circuit, according to the embodiment of the present disclosure;

FIG. 7 is a graph that represents the temperature dependence of the inductances of three types of coils, according to a first practical example that belongs to the embodiment of the present disclosure;

FIG. 8 is a view that illustrates a situation in which three internal parameters are stored in the parameter storage circuit, according to the first practical example that belongs to the embodiment of the present disclosure;

FIG. 9 is a view that illustrates a situation in which three candidate circuits that are candidates for a phase compensation circuit are installed, according to the first practical example that belongs to the embodiment of the present disclosure;

FIG. 10 is a view that schematically illustrates setting specification data disclosed by a specification of the power supply control apparatus, according to the first practical example that belongs to the embodiment of the present disclosure;

FIG. 11 is a view that illustrates a situation in which valid or invalid is set for each internal parameter on the basis of a setting command signal, according to the first practical example that belongs to the embodiment of the present disclosure;

FIG. 12 is a graph that represents the temperature dependence of the capacitance value of three types of capacitors, according to a second practical example that belongs to the embodiment of the present disclosure;

FIG. 13 is a view that schematically illustrates setting specification data disclosed by a specification of the power supply control apparatus, according to the second practical example that belongs to the embodiment of the present disclosure;

FIG. 14 is a view that illustrates a situation in which nine internal parameters are stored in the parameter storage circuit, according to a third practical example that belongs to the embodiment of the present disclosure;

FIG. 15 is a graph that represents the temperature dependence of the series resistance value of three types of coils, according to a fourth practical example that belongs to the embodiment of the present disclosure;

FIG. 16 is a partial block diagram of the power supply apparatus, according to the fourth practical example that belongs to the embodiment of the present disclosure;

FIG. 17 is a view that illustrates contents of three internal parameters, according to the fourth practical example that belongs to the embodiment of the present disclosure; and

FIG. 18 is a view that schematically illustrates setting specification data disclosed by a specification of the power supply control apparatus, according to the fourth practical example that belongs to the embodiment of the present disclosure.

### DETAILED DESCRIPTION

With reference to the drawings, examples of an embodiment of the present disclosure are described in detail below. In the drawings referenced, the same reference symbols are added to the same portions, and duplicative description pertaining to the same portions is omitted in principle. Note that, for the simplification of the description in the present specification, characters or reference symbols that refer to information, signals, physical quantities, functional units, circuits, elements, components, or other parts may be provided in order to omit or abbreviate the names of the information, the signals, the physical quantities, the functional units, the circuits, the elements, the components, or other parts corresponding to the characters or reference symbols.

First, description is provided regarding several terms used in the description of the embodiment according to the present disclosure. Ground indicates a reference conductor having an electric potential of 0 V (zero volts) that will serve as a reference, or indicates an electric potential of 0 V itself. The reference conductor may be formed by using a conductor such as a metal. The electric potential of 0 V may be referred to as a ground electric potential. In the embodiment of the present disclosure, in particular, a voltage indicated without providing a reference represents an electric potential that is viewed with reference to ground.

Level indicates the level (height) of an electric potential, and a high level for any signal or voltage to which attention is given has an electric potential that is higher than that of a low level. For any signal or voltage to which attention is given, switching from a low level to a high level may be referred to as a rising edge, and switching from a high level to a low level may be referred to as a falling edge.

For any transistor configured as a field-effect transistor (FET) that is exemplified by a MOSFET, an on state indicates a state where a drain and a source of the transistor are electrically conducted, and an off state indicates a state where the drain and the source of the transistor are not electrically conducted (a cutoff state). The same also applies to transistors that are not classified as FETs. A MOSFET is understood to be an enhancement MOSFET unless otherwise specified. MOSFET is an abbreviation of “metal-oxide-semiconductor field-effect transistor.” In addition, in any MOSFET, a back gate thereof may be considered to be short-circuited to the source thereof, unless otherwise specified.

For any transistor, the time period during which the transistor is set to the on state is referred to as an on time period, and the time period during which the transistor is set to the off state is referred to as an off time period. For any transistor, the on state and the off state may be simply expressed as on and off. For any signal having a signal level that is at a high level or a low level, a time period in which the level of the signal is set to the high level is referred to as a high-level time period, and a time period in which the level of the signal is set to the low level is referred to as a low-level time period. The same also applies to any voltage having a voltage level that is at a high level or a low level.

A connection between a plurality of portions that form a circuit, such as any circuit element, wiring, or node, may be understood as indicating an electrical connection unless otherwise specified.

In a case where any two voltages that should be compared are regarded as voltages v1 and v2, a relation “v1>v2” represents that the voltage v1 is greater than the voltage v2, a relation “v1<v2” represents that the voltage v1 is less than the voltage v2, and a relation “v1=v2” represents that the value of the voltage v1 is the same as the value of the voltage v2. The same also applies in other formulas that include physical quantities other than voltages.

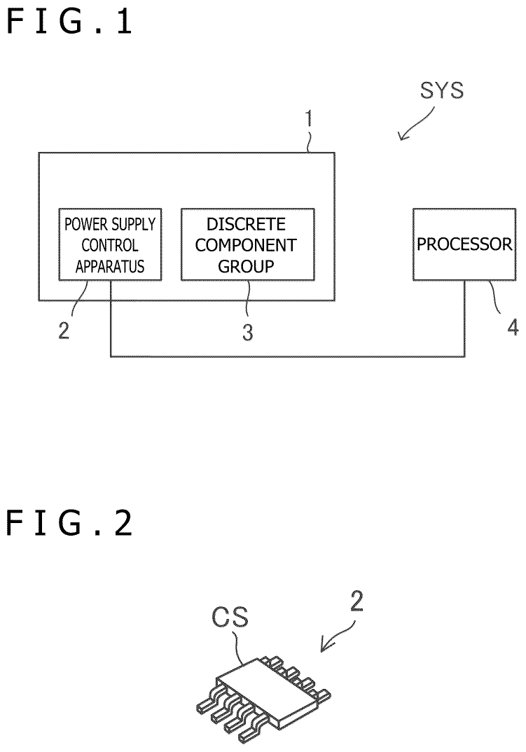

FIG. 1 is an overall block diagram of a system SYS according to an embodiment of the present disclosure. The system SYS may be referred to as a power supply system. The system SYS in FIG. 1 includes a power supply apparatus 1 and a processor 4. The power supply apparatus 1 includes a power supply control apparatus 2 that controls operation by the power supply apparatus 1, and a discrete component group 3 that includes a plurality of discrete components that are externally connected to the power supply control apparatus 2. The processor 4 is an example of an external apparatus that is provided outside the power supply control apparatus 2. The processor 4 is connected to the power supply control apparatus 2. The power supply control apparatus 2 and the processor 4 may be connected by an example that enables two-way communication therebetween. The processor 4 is a micro controller unit (MCU) or a system on a chip (SOC), for example.

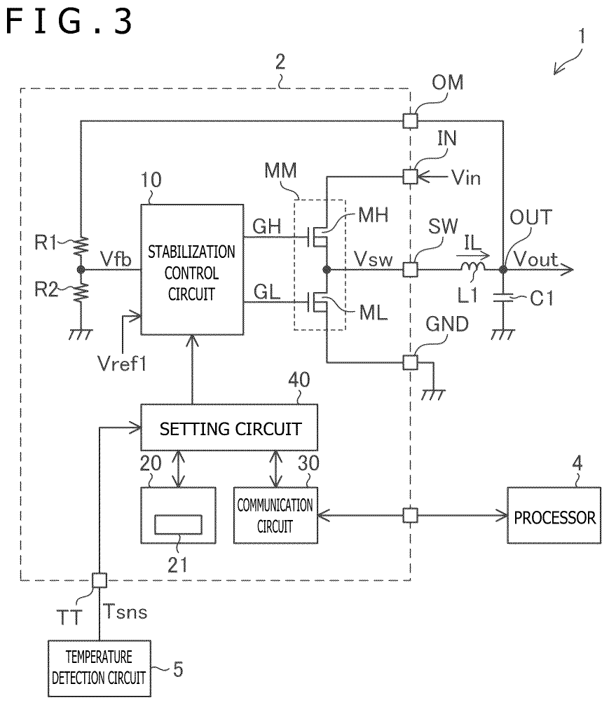

FIG. 2 illustrates an external perspective view of the power supply control apparatus 2. The power supply control apparatus 2 is an electronic component including a semiconductor chip having a semiconductor integrated circuit which is formed on a semiconductor substrate, a case CS (a package) that accommodates the semiconductor chip, and a plurality of external terminals that are exposed outside the power supply control apparatus 2 from the case CS. The power supply control apparatus 2 is formed by enclosing the semiconductor chip within the case CS which is configured by resin. Note that the number of external terminals of the power supply control apparatus 2 illustrated in FIG. 2 as well as the type of the case CS of the power supply control apparatus 2 are merely examples, and can freely be designed.

FIG. 3 illustrates an example of a configuration of the power supply apparatus 1. The discrete component group 3 in the power supply apparatus 1 in FIG. 3 includes a coil L1 and an output capacitor C1. Feedback resistors R1 and R2 are incorporated in the power supply control apparatus 2 in FIG. 3, but the feedback resistors R1 and R2 may be provided outside the power supply control apparatus 2 (accordingly, the feedback resistors R1 and R2 may be elements in the discrete component group 3). In addition, a temperature detection circuit 5 is provided in the power supply apparatus 1 in FIG. 3.

The power supply apparatus 1 in FIG. 3 is configured as a step-down switching power supply apparatus (a DC/DC converter) that generates a desired output voltage Vout from an input voltage Vin supplied from a voltage source that is not illustrated. However, the power supply apparatus 1 may be a power supply apparatus that is not a step-down switching power supply apparatus. A power supply apparatus that is not a step-down switching power supply apparatus may be a step-up switching power supply apparatus, a step-up/step-down switching power supply apparatus, or a linear power supply apparatus (a linear regulator).

The output voltage Vout is produced at an output terminal OUT. In other words, the output terminal OUT is an application terminal for the output voltage Vout (a terminal to which the output voltage Vout is applied). The output voltage Vout is supplied to a load (not illustrated) that is connected to the output terminal OUT. The processor 4 may be included in this load. In the power supply apparatus 1 in FIG. 3, the input voltage Vin and the output voltage Vout are positive direct-current voltages, and the output voltage Vout is lower than the input voltage Vin. For example, when the input voltage Vin is 12 V, it is possible to cause the output voltage Vout to stabilize to a desired target voltage Vtg (for example, 3.3 V or 5 V) that is less than 12 V.

FIG. 3 illustrates an input terminal IN, a switch terminal SW, a ground terminal GND, an output monitoring terminal OM, and a detection signal input terminal TT as some of a plurality of external terminals that are included in the power supply control apparatus 2. FIG. 3 illustrates a communication external terminal that is for transmitting and receiving communication signals between the processor 4 and the power supply control apparatus 2, but a reference symbol is not added to the communication external terminal. The communication external terminal is configured by two or more external terminals.

The input voltage Vin is supplied to the input terminal IN from a direct-current voltage source that is not illustrated and that is provided outside the power supply control apparatus 2. The coil L1 is serially interposed between the switch terminal SW and the output terminal OUT. In other words, a first end of the coil L1 is connected to the switch terminal SW, and a second end of the coil L1 is connected to the output terminal OUT. In addition, the output terminal OUT is connected to ground with the output capacitor C1 interposed therebetween. In other words, a first end of the output capacitor C1 is connected to the output terminal OUT, and a second end of the output capacitor C1 is connected to ground. The ground terminal GND is connected to ground. The output terminal OUT is connected to the output monitoring terminal OM. Note that a current that flows through the coil L1 is referred to as a coil current IL.

The power supply control apparatus 2 includes an output stage MM, a stabilization control circuit 10, a memory 20, a communication circuit 30, and a setting circuit 40, and also includes the feedback resistors R1 and R2.

The output monitoring terminal OM is connected to a first end of the feedback resistor R1. In other words, the first end of the feedback resistor R1 is connected to the output terminal OUT through the output monitoring terminal OM, and receives the output voltage Vout. A second end of the feedback resistor R1 is connected to a first end of the feedback resistor R2, and a second end of the feedback resistor R2 is connected to ground. A feedback voltage Vfb is produced at a connection node between the feedback resistors R1 and R2. The feedback resistors R1 and R2 constitute a feedback voltage generation circuit by dividing the output voltage Vout to thereby generate the feedback voltage Vfb that corresponds to the output voltage Vout. The feedback voltage Vfb is proportional to the output voltage Vout, and the feedback voltage Vfb also rises and falls in conjunction with the output voltage Vout rising and falling. The feedback voltage Vfb is inputted to the stabilization control circuit 10. However, a modification may be performed in which the output voltage Vout itself is used as the feedback voltage Vfb. In any event, the feedback voltage Vfb is a voltage that corresponds to the output voltage Vout.

The output stage MM includes a transistor MH that is a high-side transistor and a transistor ML that is a low-side transistor. The transistors MH and ML are each configured from an N-channel MOSFET. The transistors MH and ML are a pair of switching elements that are connected in series between the input terminal IN and the ground terminal GND (in other words, ground). The transistor MH functions as an output transistor, and the transistor ML functions as a synchronous rectification transistor. The transistor MH is provided on a higher electric potential side than the transistor ML. Specifically, a drain of the transistor MH is connected to the input terminal IN that is the application terminal of the input voltage Vin, and is supplied with the input voltage Vin. A source of the transistor MH and a drain of the transistor ML are connected in common to the switch terminal SW. A source of the transistor ML is connected to the ground terminal GND (and is accordingly connected to ground). However, there are cases where a current detection resistor is inserted between the source of the transistor ML and the ground terminal GND.

The stabilization control circuit 10 performs switching control of the output stage MM on the basis of the feedback voltage Vfb. In the switching control of the output stage MM, the transistors MH and ML are switched in such a manner as to be turned on and off in an alternating manner. The stabilization control circuit 10 is connected to the gates of the transistors MH and ML, and individually controls the gate electric potential of the transistors MH and ML to thereby individually set the transistors MH and ML to on or off. A square-wave switch voltage Vsw appears at the switch terminal SW due to the switching control of the output stage MM. The coil L1 and the output capacitor C1 constitute a rectification/smoothing circuit that generates the output voltage Vout by rectifying and smoothing the square-wave switch voltage Vsw that appears at the switch terminal SW. This rectification/smoothing circuit is connected to the output stage MM outside the power supply control apparatus 2.

Gate signals GH and GL as drive signals are respectively supplied to gates of the transistors MH and ML from a driver incorporated in the stabilization control circuit 10. The transistors MH and ML are turned on and off in response to the gate signals GH and GL. The transistor MH enters the on state in a high-level time period for the gate signal GH, and the transistor MH enters the off state in a low-level time period for the gate signal GH. Similarly, the transistor ML enters the on state in a high-level time period for the gate signal GL, and the transistor ML enters the off state in a low-level time period for the gate signal GL.

Basically, the transistors MH and ML are turned on and off in an alternating manner, but there are cases where the transistors MH and ML are both kept in the off state. In other words, the state of the output stage MM becomes any one of a high-output state, a low-output state, and a both-off state (a Hi-Z state). The high-output state is a state in which the transistor MH is in the on state and the transistor ML is in the off state. The low-output state is a state in which the transistor MH is in the off state and the transistor ML is in the on state. The both-off state is a state in which the transistors MH and ML are both in the off state. There is no case in which the transistors MH and ML are set to the on state at the same time. In switching control by the stabilization control circuit 10, turning the transistors MH and ML on and off in an alternating manner is a concept that includes interposing the both-off state during transitions between the low-output state and the high-output state, taking dead time or other states into account. Note that at least one of the transistors MH and ML may be provided outside the power supply control apparatus 2. The entirety of the output stage MM may be provided outside the power supply control apparatus 2.

The stabilization control circuit 10 controls on/off states for each of the transistors MH and ML through level control of the gate signals GH and GL on the basis of the feedback voltage Vfb, and collaborates with the coil L1 and the output capacitor C1 to cause generation of a desired output voltage Vout at the output terminal OUT. The stabilization control circuit 10 adjusts the output duty of the output stage MM such that the feedback voltage Vfb matches the reference voltage Vref. When a relation “Vfb=Vref” holds true, the value of the output voltage Vout matches the value of the target voltage Vtg. The output duty represents the ratio of time periods in which the output stage MM is in the high-output state, with respect to the sum of the time periods in which the output stage MM is in the high-output state and time periods in which the output stage MM is in the low-output state. The reference voltage Vref has a predetermined positive direct-current voltage value. A reference-voltage generation circuit (not illustrated) that generates one or more reference voltages on the basis of the input voltage Vin is provided in the power supply control apparatus 2.

The stabilization control circuit 10 can use any control method as a control method for stabilizing the output voltage Vout to the target voltage Vtg, and, for example, can control the state of the output stage MM by a pulse width modulation method, a pulse frequency modulation method, or a constant on-time control method.

In addition, the stabilization control circuit 10 can perform an overcurrent protection operation for protecting the coil L1 and the power supply control apparatus 2 from overcurrent, and detailed explanation of the overcurrent protection operation is given later.

Note that, although not illustrated in particular, an internal power supply circuit that generates one or more internal power supply voltages on the basis of the input voltage Vin is provided in the power supply control apparatus 2. Each circuit inside the power supply control apparatus 2 can be driven by using an internal power supply voltage or the input voltage Vin as a drive voltage. In addition, the gate signal GL is a signal for which the ground electric potential is employed as a reference, whereas the gate signal GH is a signal for which the electric potential of the switch terminal SW is employed as a reference. A low-level gate signal GH has the electric potential of the switch terminal SW, and a high-level gate signal GH is higher than the electric potential of the switch terminal SW by a predetermined voltage. The predetermined voltage here is greater than the gate threshold voltage of the transistor MH. It is possible to use a well-known voltage-boost power supply (a bootstrap circuit or other circuits) to generate a high-level gate signal GH. The transistor MH may be configured by a P-channel MOSFET, and a voltage-boost power supply is unnecessary in this case.

In addition, as a modification, a diode rectification method may be employed in the power supply apparatus 1. In this case, in place of the transistor ML, a synchronous rectification diode having an anode that is connected to the ground terminal GND and a cathode that is connected to the switch terminal SW is provided as a rectification element in the power supply apparatus 1. In this case, only the transistor MH is turned on and off in switching control of the output stage MM. In any event, in switching control of the output stage MM, the transistor MH is switched between on and off, whereby the output voltage Vout is generated on the basis of the current (IL) that flows through the coil L1.

The memory 20 includes a volatile memory and a non-volatile memory, and stores various items of information that are referred to inside the power supply control apparatus 2. A parameter storage circuit 21 (details thereof are described below), which includes the non-volatile memory, is provided in the memory 20.

The communication circuit 30 performs two-way communication with the processor 4. As an interface for two-way communication between the communication circuit 30 and the processor 4, for example, a serial peripheral interface (SPI) may be used, or an interface according to inter-integrated circuit (I²C) or microwire may be used. The processor 4 can transmit various commands as command signals to the communication circuit 30. The setting circuit 40 and the stabilization control circuit 10 operate according to command signals received by the communication circuit 30.

The setting circuit 40 performs setting of an operation condition for the stabilization control circuit 10, and other processes, on the basis of data stored in the memory 20, a command signal received by the communication circuit 30, and a signal (a later-described temperature detection signal Tsns) supplied from the temperature detection circuit 5.

The temperature detection circuit 5 detects a temperature Tmp of a position to be measured to thereby generate the temperature detection signal Tsns. The temperature detection signal Tsns is inputted to the detection signal input terminal TT from the temperature detection circuit 5, and is supplied to the setting circuit 40 through the detection signal input terminal TT. The temperature detection circuit 5 has a temperature measurement element (such as a resistance thermometer, a linear resistor, or a thermistor) that is disposed at the position to be measured, and can use the temperature measurement element to detect the temperature Tmp. The temperature detection circuit 5 may be a semiconductor temperature sensor. The semiconductor temperature sensor has a silicon diode that is disposed at the position to be measured, and uses the temperature characteristic of the forward voltage of the diode to detect the temperature Tmp. In place of the forward voltage of a diode, the base-emitter voltage of a bipolar transistor may be used to detect the temperature Tmp.

The temperature detection signal Tsns is a voltage signal that represents the temperature Tmp (is a voltage signal that indicates a detected value for the temperature Tmp). The temperature detection signal Tsns may be an analog voltage signal, or may be a digital voltage signal. In any event, the value of the temperature Tmp is specified by the signal value of the temperature detection signal Tsns.

The position to be measured is set outside the power supply control apparatus 2. The temperature detection circuit 5 may detect, as the temperature Tmp, the temperature of the environment in which the system SYS is disposed. In a case where the power supply control apparatus 2, the coil L1, and the output capacitor C1 are disposed sufficiently close to one another, the temperature Tmp represents the temperature of the power supply control apparatus 2, the temperature of the coil L1, and the temperature of the output capacitor C1. In a case of paying attention to the coil L1 in particular, the position to be measured may be a position that is close to the coil L1 as much as possible and the temperature Tmp will represent the temperature of the coil L1 with high accuracy in this case. In a case of paying attention to the output capacitor C1 in particular, the position to be measured may be a position that is close to the output capacitor C1 as much as possible, and the temperature Tmp will represent the temperature Tmp of the output capacitor C1 with high accuracy in this case. The setting circuit 40 recognizes the temperature Tmp from the temperature detection signal Tsns. Note that it is not mandatory for the temperature detection circuit 5 to be in the power supply apparatus 1. In a case where the temperature detection circuit 5 is not provided in the power supply apparatus 1, the detection signal input terminal TT of the power supply control apparatus 2 can be omitted.

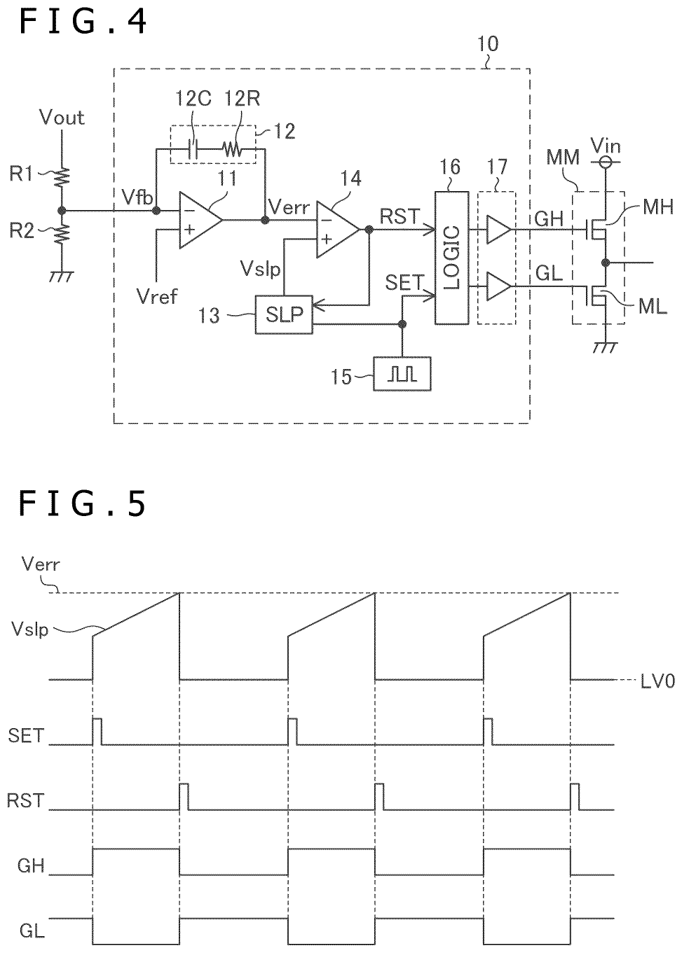

FIG. 4 illustrates an example of an internal configuration of the stabilization control circuit 10. FIG. 4 illustrates an example of the configuration of the stabilization control circuit 10 that controls the output duty of the output stage MM by the pulse width modulation method. The stabilization control circuit 10 in FIG. 4 includes an error amplifier 11, a phase compensation circuit 12, a slope generation circuit 13, a comparator 14, a SET issuing circuit 15, a logic circuit 16, and a driver 17. The phase compensation circuit 12 includes a resistor 12R and a capacitor 12C. The error amplifier 11 may be a transconductance amplifier. FIG. 5 illustrates waveforms for some signals that pertain to the configuration in FIG. 4.

The feedback voltage Vfb is inputted to the inverting input terminal of the error amplifier 11, and the reference voltage Vref is inputted to the non-inverting input terminal of the error amplifier 11. The error amplifier 11 outputs, from its own output terminal, an error signal Verr that corresponds to the error between the feedback voltage Vfb and the reference voltage Vref. Feedback control for reducing the error between the feedback voltage Vfb and the reference voltage Vref to zero is realized by the stabilization control circuit 10. In order to stabilize the feedback control, the phase compensation circuit 12 compensates for the phase of the error signal Verr. In the configuration example in FIG. 4, a first end of the resistor 12R is connected to the output terminal of the error amplifier 11 (and is accordingly connected to wiring to which the error signal Verr is applied), a second end of the resistor 12R is connected to a first end of the capacitor 12C, and a second end of the capacitor 12C is connected to the inverting input terminal of the error amplifier 11. However, the connection relation between the phase compensation circuit 12 and the error amplifier 11 is not limited to that illustrated in FIG. 4. For example, the second end of the capacitor 12C may be connected to ground.

The slope generation circuit 13 generates and outputs a slope signal Vslp. The slope signal Vslp and the error signal Verr are voltage signals. Accordingly, the slope signal Vslp and the error signal Verr may be interpreted as a slope voltage Vslp and an error voltage Verr. In time periods in which the output stage MM is set to the high-output state, the slope generation circuit 13 causes the slope signal Vslp to monotonically rise at a predetermined rate of increase (refer to FIG. 5). In the time period in which the output stage MM is set to the high-output state, the slope generation circuit 13 may generate, as the slope signal Vslp, a signal resulting from summing a ramp signal that monotonically rises and a signal that is proportional to the coil current IL. The slope generation circuit 13 keeps the slope signal Vslp at a sufficiently low level in time periods in which the output stage MM is set to the low-output state (refer to FIG. 5). The slope generation circuit 13 receives signals SET and RST, which are described below, and can recognize whether the output stage MM is in the high-output state or the low-output state on the basis of the signals SET and RST.

The error signal Verr and the slope signal Vslp are respectively inputted to the inverting input terminal and the non-inverting input terminal of the comparator 14. The comparator 14 compares the error signal Verr and the slope signal Vslp, and outputs the signal RST that indicates a result of the comparison. The signal RST is a binary signal that has a high level or a low level. The comparator 14 outputs a high-level signal RST in the state where a relation “Vslp≥Verr” holds true, and outputs a low-level signal RST in the state where a relation “Vslp<Verr” holds true.

The SET issuing circuit 15 encloses an oscillator that generates a clock signal, or receives a clock signal from an oscillator. The clock signal is a square wave signal that has a predetermined clock frequency, and thus holds a high level and a low level in an alternating manner. The SET issuing circuit 15 generates and outputs the signal SET that is synchronized with the clock signal. The SET issuing circuit 15 sets the signal SET to the low level in principle, and sets the signal SET to the high level for only a very small amount of time, triggered by a rising edge occurring in the clock signal (refer to FIG. 5).

The signals SET and RST are inputted to the logic circuit 16. The driver 17 includes a high-side driver that is connected to the gate of the transistor MH and that drives the gate of the transistor MH and a low-side driver that is connected to the gate of the transistor ML and that drives the gate of the transistor ML. The logic circuit 16 uses the driver 17 to individually set the transistors MH and ML to on or off, on the basis of the signals SET and RST.

FIG. 5 illustrates examples of the waveforms of the signals Verr, Vslp, SET, RST, GH, and GL. In FIG. 5, it is assumed that the signal resulting from summing the ramp signal and the signal proportional to the coil current IL is generated as the slope signal Vslp, and circumstances in which a positive coil current IL constantly flows to the coil L1 are assumed. The coil current IL, which flows from the switch terminal SW toward the output terminal OUT, has a positive polarity (refer to FIG. 3). Under these assumptions, the logic circuit 16 repeats, at the clock frequency, an operation for switching the output stage MM from the low-output state to the high-output state in synchronization with rising edges of the signal SET, and switching the output stage MM from the high-output state to the low-output state in synchronization with rising edges of the signal RST. The slope generation circuit 13 starts outputting the abovementioned signal resulting from the summing as the slope signal Vslp triggered by a rising edge of the signal SET, lowers the slope signal Vslp to a sufficiently low level LV0 when a rising edge of the signal RST occurs, and keeps the slope signal Vslp at the level LV0 until the next rising edge occurs in the signal SET. The level LV0 is lower than the lower limit of the range of fluctuation of the error signal Verr. When a rising edge occurs in the signal RST due to the slope signal Vslp reaching the error signal Verr according to the slope signal Vslp rising, the level of the slope signal Vslp immediately decreases to the level LV0. Therefore, a high-level time period for the signal RST becomes very short.

A relation “Vfb<Vref” holding true produces an increase in the output duty due to the error signal Verr rising, and the output voltage Vout is caused to rise as a result. Conversely, a relation “Vfb>Vref” holding true produces a decrease in the output duty due to the error signal Verr falling, and the output voltage Vout is caused to fall as a result. In this manner, the stabilization control circuit 10 controls the state of the output stage MM such that the error between the feedback voltage Vfb and the reference voltage Vref is reduced to zero. The above-described error signal Verr is an example of an internal signal that corresponds to this error.

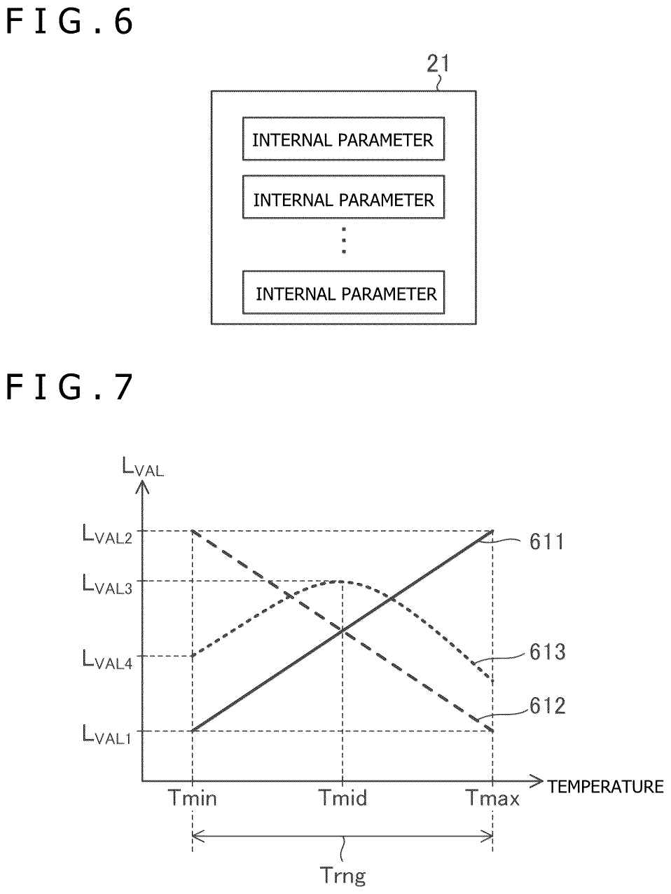

Incidentally, the power supply control apparatus 2 is configured such that a temperature characteristic of the stabilization control circuit 10 can be switched among a plurality thereof. A parameter for defining the temperature characteristic of the stabilization control circuit 10 is referred to as an internal parameter. As illustrated in FIG. 6, a plurality of internal parameters are stored in the parameter storage circuit 21 in a non-volatile manner. Each internal parameter is written to the parameter storage circuit 21 during a stage where the power supply control apparatus 2 is manufactured or shipped. The setting circuit 40 sets one of the plurality of internal parameters on the basis of a setting command signal from the processor 4 to valid, and sets the temperature characteristic of the stabilization control circuit 10 according to the internal parameter that has been set to valid. The temperature characteristic of the stabilization control circuit 10 changes when a certain internal parameter among the plurality of internal parameters is set to valid, or when another internal parameter is set to valid. In other words, the temperature characteristic of the stabilization control circuit 10 when a certain internal parameter is set to valid is mutually different from the temperature characteristic of the stabilization control circuit 10 when another internal parameter is set to valid.

In a plurality of practical examples, description is given below for several specific examples of operation, applied techniques, modified techniques, or other techniques that pertain to the power supply apparatus 1 or the power supply control apparatus 2. Matters described above in the present embodiment are applied to each of the following practical examples unless there is an inconsistency or unless otherwise specified. In each practical example, the description in each practical example may prevail in a case where matters described are not consistent with matters described above. In addition, unless there is an inconsistency, matters described in any practical example among the plurality of practical examples described below can also be applied to any other practical example (in other words, it is possible to combine any two or more practical examples among the plurality of practical examples).

### FIRST PRACTICAL EXAMPLE

A first practical example is described. A circuit element that is provided outside the power supply control apparatus 2 and that realizes a power conversion operation for converting the input voltage Vin to the output voltage Vout in collaboration with the stabilization control circuit 10 and the output stage MM is referred to as an external circuit element. The coil L1 and the output capacitor C1 correspond to the external circuit element.

A designer of the power supply apparatus 1 or the system SYS incorporates the coil L1, which is selected among various types of coils having diverse temperature characteristics, in the power supply apparatus 1. FIG. 7 illustrates the temperature characteristics of the inductance of each of first to third types of coils. The inductance is represented by the reference symbol “L_{VAL}.” In FIG. 7, a solid line segment 611 represents the temperature characteristic of the inductance L_{VAL} for the first type of coil, a dashed line segment 612 represents the temperature characteristic of the inductance L_{VAL} for the second type of coil, and a dashed curve 613 represents the temperature characteristic of the inductance L_{VAL} for the third type of coil. The minimum temperature and the maximum temperature in a predetermined temperature range Trng are respectively referred to as a minimum temperature Tmin and a maximum temperature Tmax. An intermediate temperature Tmid belongs to the temperature range Trng. A relation “Tmin<Tmid<Tmax” holds true. The temperature range Trng matches a temperature range in which the power supply control apparatus 2 and the external circuit element are used, or is included in in the temperature range in which the power supply control apparatus 2 and the external circuit element are used.

In order to provide a more specific description, it is assumed that the first to third types of coils have the following temperature characteristics. Inductances L_{VAL1} to L_{VAL4} indicated in FIG. 7 satisfy a relation “L_{VAL1}<L_{VAL4}<L_{VAL3}<L_{VAL2}.” As indicated by the solid line segment 611, the inductance L_{VAL} for the first type of coil is the inductance L_{VAL1} when the temperature of the first type of coil matches the minimum temperature Tmin, and is the inductance L_{VAL2} when the temperature of the first type of coil matches the maximum temperature Tmax. The inductance L_{VAL} for the first type of coil monotonically increases as the temperature of the first type of coil rises from the minimum temperature Tmin to the maximum temperature Tmax. As indicated by the dashed line segment 612, the inductance L_{VAL} for the second type of coil is the inductance L_{VAL2} when the temperature of the second type of coil matches the minimum temperature Tmin, and is the inductance L_{VAL1} when the temperature of the second type of coil matches the maximum temperature Tmax. The inductance L_{VAL} for the second type of coil monotonically decreases as the temperature of the second type of coil rises from the minimum temperature Tmin to the maximum temperature Tmax.

As indicated by the dashed curve 613, the inductance L_{VAL} for the third type of coil is the inductance L_{VAL4} when the temperature of the third type of coil matches the minimum temperature Tmin, and is the inductance L_{VAL3} when the temperature of the third type of coil matches the intermediate temperature Tmid. The inductance L_{VAL} for the third type of coil monotonically increases as the temperature of the third type of coil rises from the minimum temperature Tmin to the intermediate temperature Tmid, and the inductance L_{VAL} for the third type of coil monotonically decreases as the temperature of the third type of coil rises from the intermediate temperature Tmid to the maximum temperature Tmax. When the temperature of the third type of coil matches the maximum temperature Tmax, the inductance L_{VAL} for the third type of coil is less than the inductance L_{VAL3} and is greater than the inductance L_{VAL1}.

The power supply control apparatus 2 needs to stably perform feedback control, regardless of which of the various types of coils is used as the coil L1. Instead of the actual power supply control apparatus 2, a power supply control apparatus that is configured such that the temperature characteristic of the phase compensation circuit 12 is not able to be changed is referred to as a virtual power supply control apparatus J1. In the virtual power supply control apparatus J1, the phase compensation circuit 12 is designed by employing a relatively large margin such that stable feedback control is realized, regardless of which of the various types of coils is used as the coil L1. This means that the virtual power supply control apparatus J1 is not optimized for the first type of coil, is not optimized for the second type of coil, and is not optimized for the third type of coil.

If it is possible to establish that the coil L1 is the first type of coil, it is possible to apply a temperature characteristic which is suitable for the temperature characteristic of the first type of coil to the phase compensation circuit 12. Similarly, if it is possible to establish that the coil L1 is the second type of coil, it is possible to apply a temperature characteristic which is suitable for the temperature characteristic of the second type of coil to the phase compensation circuit 12. The same also applies in a case where it is possible to establish that the coil L1 is another type of coil.

Taking this into consideration, in the first practical example, the power supply control apparatus 2 is configured such that it becomes possible to switch between a plurality of temperature characteristics for the phase compensation circuit 12, as the temperature characteristic of the stabilization control circuit 10. In the first practical example, it is assumed that the temperature characteristic of the output capacitor C1 is designated by the specification of the power supply control apparatus 2, and thus, the temperature characteristic of the output capacitor C1 is established by a temperature characteristic that is designated in the specification during a design stage for the power supply control apparatus 2. In other words, in the first practical example, it is considered that, among the temperature characteristic for the coil L1 and the temperature characteristic for the output capacitor C1, only the coil L1 has various temperature characteristics.

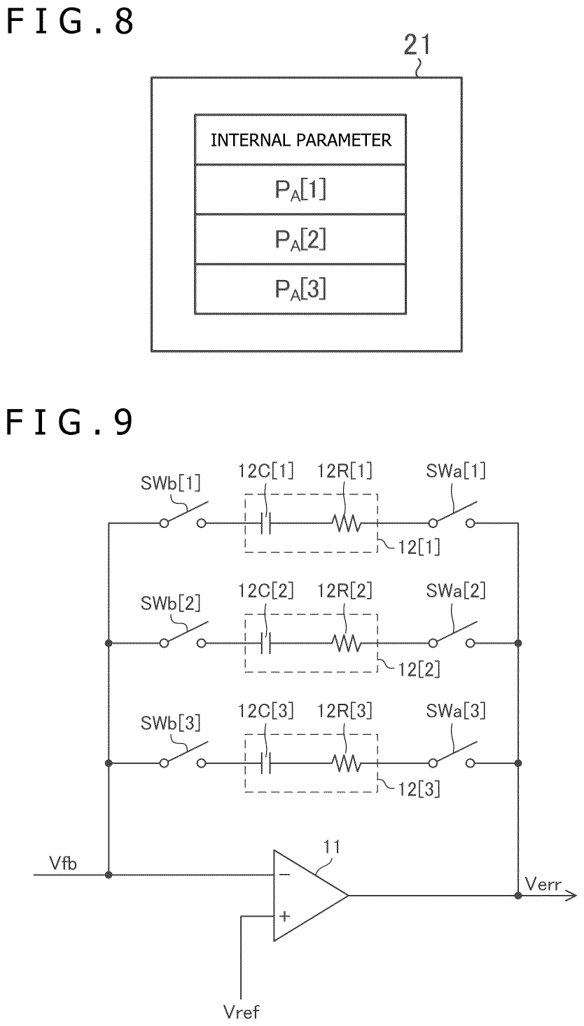

The plurality of internal parameters stored in the parameter storage circuit 21 include internal parameters P_{A}[1] through P_{A}[3] that are illustrated in FIG. 8. The internal parameters P_{A}[1] through P_{A}[3] each define a temperature characteristic for the phase compensation circuit 12. The setting circuit 40 sets any one of the internal parameters P_{A}[1] through P_{A}[3] to valid and sets the other two to invalid, on the basis of a setting command signal received by the communication circuit 30 (a setting command signal received from the processor 4).

The setting command signal received by the communication circuit 30 includes one piece of command data among pieces of command data D_{A}[1] through D_{A}[3]. Command data D_{A}[i] corresponds to an internal parameter P_{A}[i], and is for commanding that the internal parameter P_{A}[i] be set to valid. Accordingly, in a case where a setting command signal received by the communication circuit 30 includes the command data D_{A}[i], the setting circuit 40 sets the internal parameter P_{A}[i] among the internal parameters P_{A}[1] through P_{A}[3] to valid, and sets the other two to invalid. In the first practical example, i indicates 1, 2, or 3.

The setting circuit 40, in a case of having set the internal parameter P_{A}[i] to valid, sets the temperature characteristic for the phase compensation circuit 12 to a temperature characteristic TCA[i] according to the valid internal parameter P_{A}[i]. Temperature characteristics TCA[1] through TCA[3] are mutually different. In order to realize switching of the temperature characteristic of the phase compensation circuit 12, three candidate circuits 12[1] through 12[3] as candidates for the phase compensation circuit 12 are provided in advance in the power supply control apparatus 2, as illustrated in FIG. 9. The candidate circuit 12[1] is a series circuit of a capacitor 12C[1] and a resistor 12R[1], and corresponds to the internal parameter P_{A}[1]. The candidate circuit 12[2] is a series circuit of a capacitor 12C[2] and a resistor 12R[2], and corresponds to the internal parameter P_{A}[2]. The candidate circuit 12[3] is a series circuit of a capacitor 12C[3] and a resistor 12R[3], and corresponds to the internal parameter P_{A}[3].

Switches SWa[1] to SWa[3] and SWb[1] to SWb[3] are provided in advance in the power supply control apparatus 2 such that any one of the candidate circuits 12[1] through 12[3] selectively functions as the phase compensation circuit 12. The switches SWa[1] to SWa[3] and SWb[1] to SWb[3] are each an analog switch that is formed from a MOSFET. A first end of a candidate circuit 12[i] is connected to the output terminal of the error amplifier 11 with the switch SWa[i] interposed therebetween, and a second end of the candidate circuit 12[i] is connected to the inverting input terminal of the error amplifier 11 with the switch SWb[i] interposed therebetween. It may be understood that a first multiplexer is configured by the switches SWa[1] through SWa[3], and a second multiplexer is configured by the switches SWb[1] through SWb[3].

The internal parameter P_{A}[i] is data for instructing that only the switches SWa[i] and SWb[i] among the switches SWa[1] to SWa[3] and SWb[1] to SWb[3] be set to on, and the four remaining switches be set to off. Accordingly, in a case where the internal parameter P_{A}[1] is set to valid, the candidate circuit 12[1] is used as the phase compensation circuit 12, and the capacitor 12C[1] and the resistor 12R[1] function as the capacitor 12C and the resistor 12R in FIG. 4. Similarly, in a case where the internal parameter P_{A}[2] is set to valid, the candidate circuit 12[2] is used as the phase compensation circuit 12, and the capacitor 12C[2] and the resistor 12R[2] function as the capacitor 12C and the resistor 12R in FIG. 4. Similarly, in a case where the internal parameter P_{A}[3] is set to valid, the candidate circuit 12[3] is used as the phase compensation circuit 12, and the capacitor 12C[3] and the resistor 12R[3] function as the capacitor 12C and the resistor 12R in FIG. 4.

The temperature characteristic of the candidate circuit 12[i] is defined by the temperature characteristic of the capacitor 12C[i] and the temperature characteristic of the resistor 12R[i]. The temperature characteristics of the capacitors 12C[1] through 12C[3] are mutually different, and the temperature characteristics of the resistors 12R[1] through 12R[3] are mutually different. As a result, the temperature characteristics of the candidate circuits 12[1] through 12[3] are mutually different. Accordingly, the temperature characteristic of the phase compensation circuit 12 when the candidate circuit 12[1] is used as the phase compensation circuit 12, the temperature characteristic of the phase compensation circuit 12 when the candidate circuit 12[2] is used as the phase compensation circuit 12, and the temperature characteristic of the phase compensation circuit 12 when the candidate circuit 12[3] is used as the phase compensation circuit 12 are mutually different.

In the first practical example, the temperature characteristic of the candidate circuit 12[i] is designed such that, inter alia, feedback control and response performance for the power supply control apparatus 2 are optimized by using the candidate circuit 12[i] as the phase compensation circuit 12 in a case where the ith type of coil is used as the coil L1. Basically, in a case where the ith type of coil is used as the coil L1, the candidate circuit 12[i] may be caused to have a temperature characteristic such that an amount of change in the inductance of the coil L1 due to temperature is offset.

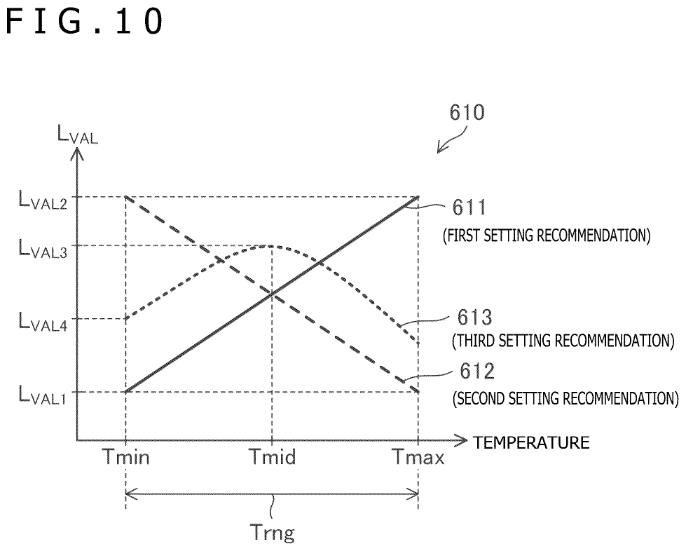

In the following manner, a designer of the system SYS determines a setting command that should be transmitted from the processor 4. It is presupposed that the specification of the power supply control apparatus 2 (a data sheet) is disclosed to the designer of the system SYS. The specification of the power supply control apparatus 2 discloses setting specification data 610 as illustrated in FIG. 10. The setting specification data 610 illustrates plots (611 through 613) that indicate the temperature characteristics of the first to third types of coils. In addition, the setting specification data 610 indicates information recommending enabling a first setting in a case CS1_EX1 in which the inductance of the coil L1 has a temperature characteristic that matches or is similar to the solid line segment 611, information recommending enabling a second setting in a case CS2_EX1 in which the inductance of the coil L1 has a temperature characteristic that matches or is similar to the dashed line segment 612, and information recommending enabling a third setting in a case CS3_EX1 in which the inductance of the coil L1 has a temperature characteristic that matches or is similar to the dashed curve 613. An ith setting corresponds to a setting for using the candidate circuit 12[i] for the phase compensation circuit 12. In order to enable the ith setting, information to the effect that a setting command signal that includes the command data D_{A}[i] should be transmitted to the power supply control apparatus 2 is indicated in the specification of the power supply control apparatus 2.

The designer of the system SYS may refer to the specification, which is for the power supply control apparatus 2 and includes the setting specification data 610, and design the processor 4 such that a setting command signal that includes the command data D_{A}[1] for enabling the first setting is transmitted to the power supply control apparatus 2 in the case CS1_EX1, a setting command signal that includes the command data D_{A}[2] for enabling the second setting is transmitted to the power supply control apparatus 2 in the case CS2_EX1, and a setting command signal that includes the command data D_{A}[3] for enabling the third setting is transmitted to the power supply control apparatus 2 in the case CS3_EX1. In this manner, a setting command signal transmitted to the power supply control apparatus 2 includes data (any one of pieces of the command data D_{A}[1] through D_{A}[3]) that corresponds to the temperature characteristic of the coil L1.

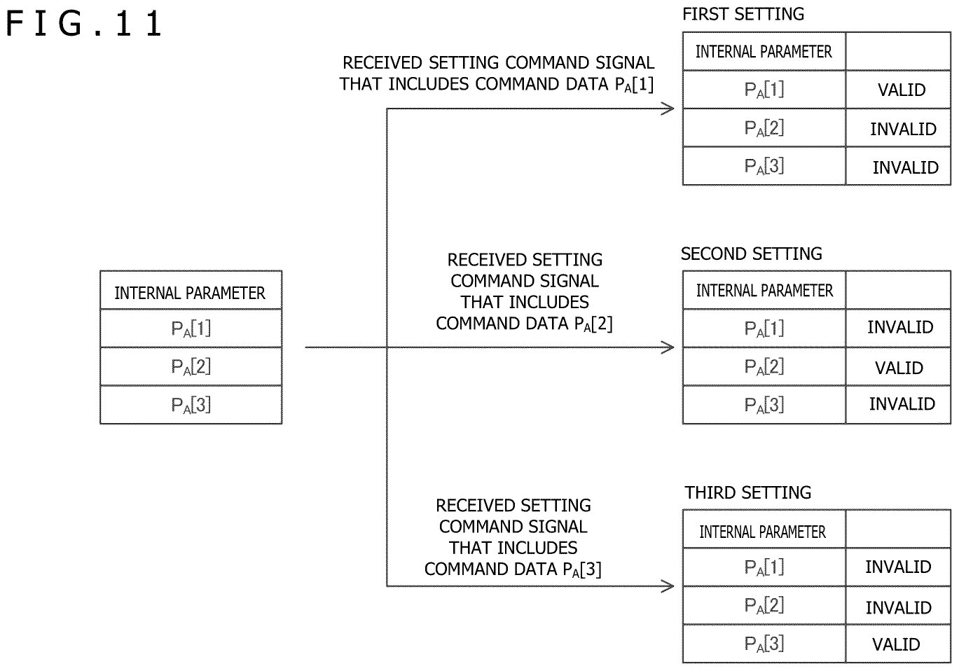

When supply of power to the power supply control apparatus 2 is started and the power supply control apparatus 2 activates, an initial sequence operation that handles, inter alia, initialization of internal circuits in the power supply control apparatus 2 is executed. In a time period in which the initial sequence operation is executed, the output stage MM is kept in the both-off state, and switching control of the output stage MM is performed after the completion of the initial sequence operation (similar even in other practical examples described below). For example, the setting circuit 40 awaits reception of a setting command signal during the initial sequence operation. As illustrated in FIG. 11, when a setting command signal is received by the communication circuit 30, the setting circuit 40 sets any one of the internal parameters P_{A}[1] through P_{A}[3] to valid, according to the received setting command signal. Subsequently, switching control is started according to the valid internal parameter.

By virtue of the first practical example, it is possible to use a phase compensation circuit 12 having an optimal temperature characteristic in alignment with the temperature characteristic of the coil L1 that is actually disposed outside the power supply control apparatus 2, and optimization of, inter alia, feedback control and response performance for the power supply control apparatus 2 can be expected. The designer of the power supply control apparatus 2 is different from the designer of the system SYS. The designer of the system SYS purchases the power supply control apparatus 2 from a business entity that manufactures and sells the power supply control apparatus 2, and incorporates the power supply control apparatus 2 in the system SYS. In these circumstances, instead of directly designating the temperature characteristic of the phase compensation circuit 12 through the processor 4, the designer of the system SYS selects which of the first through third settings to enable with reference to the specification of the power supply control apparatus 2. Accordingly, from the standpoint of the business entity that manufactures and sells the power supply control apparatus 2, it is possible to optimize the temperature characteristic of the phase compensation circuit 12 in alignment with each system SYS, in a state where details of the internal structure of the power supply control apparatus 2 are made to be a black box (in other words, with an example in which the details are not disclosed to the designer of the system SYS). Optimization of a transient response characteristic becomes possible due to the optimization of the temperature characteristic. Accordingly, there is a higher possibility of being able to maintain a favorable power conversion operation even if output capacitance (the capacitance of the output capacitor C1) is reduced. In other words, it becomes possible to reduce the output capacitance, and, in a case of using a circuit that connects a plurality of capacitors in parallel to form the output capacitor C1, it also becomes possible to reduce the number of components (reduce the number of capacitors that are connected in parallel).

Note that, in order to simplify the description while providing a more specific description, description has been given for a method of setting the temperature characteristic of the phase compensation circuit 12 to any one of three types after assuming that three types of coils are used as the coil L1. However, the number of types of coils used as the coil L1 may be two or more, and, in conjunction therewith, the number of types of temperature characteristics for the phase compensation circuit 12 may be two or more.

### SECOND PRACTICAL EXAMPLE

A second practical example is described. In the second practical example, attention is given to the temperature characteristic of the output capacitor C1 instead of the temperature characteristic of the coil L1. Regarding matters not particularly described in the second practical example, the description in the first practical example applies to the second practical example unless there is an inconsistency.

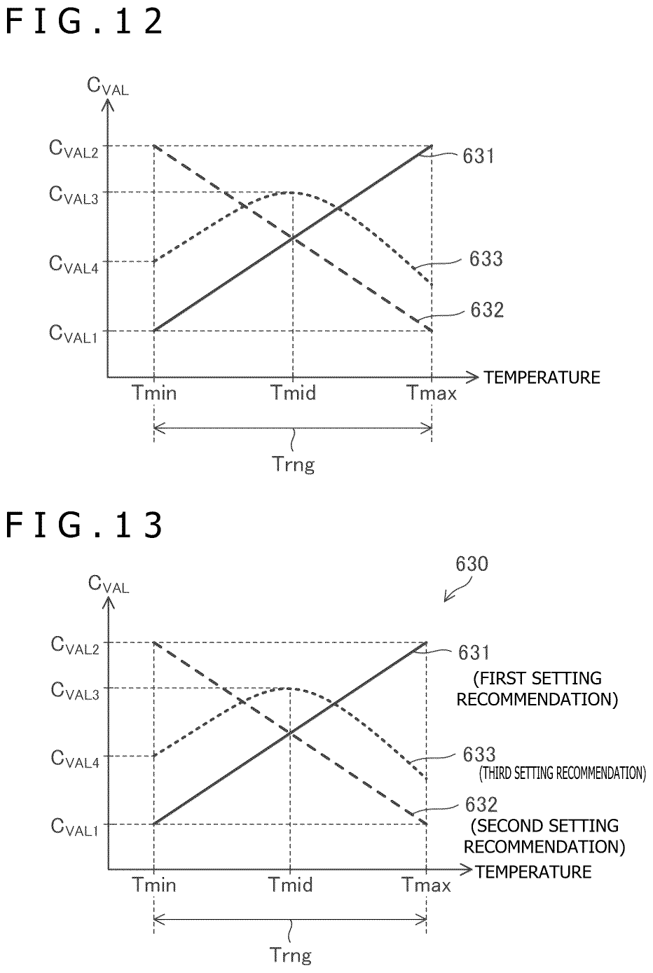

The designer of the power supply apparatus 1 or the system SYS incorporates the output capacitor C1, which is selected among various types of capacitors having diverse temperature characteristics, in the power supply apparatus 1. FIG. 12 illustrates temperature characteristics for capacitance values for each of first to third types of capacitors. Capacitance values are represented by the reference symbol “C_{VAL}.” In FIG. 12, a solid line segment 631 represents the temperature characteristic of the capacitance value C_{VAL} for the first type of capacitor, a dashed line segment 632 represents the temperature characteristic of the capacitance value C_{VAL} for the second type of capacitor, and a dashed curve 633 represents the temperature characteristic of the capacitance value C_{VAL} for the third type of capacitor.

In order to provide a more specific description, it is assumed that the first to third types of capacitors have the following temperature characteristics. Capacitance values C_{VAL1} through C_{VAL4} indicated in FIG. 12 satisfy “C_{VAL1}<C_{VAL4}<C_{VAL3}<C_{VAL2}.” As indicated by the solid line segment 631, the capacitance value C_{VAL} for the first type of capacitor is the capacitance value C_{VAL1} when the temperature of the first type of capacitor matches the minimum temperature Tmin, and is the capacitance value C_{VAL2} when the temperature of the first type of capacitor matches the maximum temperature Tmax. The capacitance value C_{VAL} for the first type of capacitor monotonically increases as the temperature of the first type of capacitor rises from the minimum temperature Tmin to the maximum temperature Tmax. As indicated by the dashed line segment 632, the capacitance value C_{VAL} for the second type of capacitor is the capacitance value C_{VAL2} when the temperature of the second type of capacitor matches the minimum temperature Tmin, and is the capacitance value C_{VAL1} when the temperature of the second type of capacitor matches the maximum temperature Tmax. The capacitance value C_{VAL} for the second type of capacitor monotonically decreases as the temperature of the second type of capacitor rises from the minimum temperature Tmin to the maximum temperature Tmax.

As indicated by the dashed curve 633, the capacitance value C_{VAL} for the third type of capacitor is the capacitance value C_{VAL4} when the temperature of the third type of capacitor matches the minimum temperature Tmin, and is the capacitance value C_{VAL3} when the temperature of the third type of capacitor matches the intermediate temperature Tmid. The capacitance value C_{VAL} for the third type of capacitor monotonically increases as the temperature of the third type of capacitor increases from the minimum temperature Tmin to the intermediate temperature Tmid, and the capacitance value C_{VAL} for the third type of capacitor monotonically decreases as the temperature of the third type of capacitor increases from the intermediate temperature Tmid to the maximum temperature Tmax. When the temperature of the third type of capacitor matches the maximum temperature Tmax, the capacitance value C_{VAL} for the third type of capacitor is less than the capacitance value C_{VAL3} and greater than the capacitance value C_{VAL1}.

The power supply control apparatus 2 needs to stably perform feedback control, regardless of which of the various types of capacitors is used as the output capacitor C1. In the virtual power supply control apparatus J1, which is configured such that the temperature characteristic of the phase compensation circuit 12 is not able to be changed, the phase compensation circuit 12 is designed by employing a relatively large margin such that stable feedback control is realized, regardless of which of the various types of capacitors is used as the output capacitor C1. This means that the virtual power supply control apparatus J1 is not optimized for the first type of capacitor, is not optimized for the second type of capacitor, and is not optimized for the third type of capacitor.

Similarly to the technique described in the first practical example, if it is possible to establish that the output capacitor C1 is an ith type of capacitor, it is possible to employ, for the phase compensation circuit 12, a temperature characteristic that is suitable for the temperature characteristic of the ith type of capacitor. Taking this into consideration, in the second practical example, similarly to in the first practical example, the power supply control apparatus 2 is configured such that it becomes possible to switch between a plurality of temperature characteristics for the phase compensation circuit 12, as the temperature characteristic of the stabilization control circuit 10. However, in the second practical example, it is assumed that the temperature characteristic of the coil L1 is designated by the specification of the power supply control apparatus 2, and thus the temperature characteristic of the coil L1 is established by a temperature characteristic that is designated in the specification during a design stage for the power supply control apparatus 2. In other words, in the second practical example, it is considered that, among the temperature characteristic for the coil L1 and the temperature characteristic for the output capacitor C1, only the output capacitor C1 has various temperature characteristics.

The plurality of internal parameters stored in the parameter storage circuit 21 include the above-described internal parameters P_{A}[1] through P_{A}[3] (refer to FIG. 8). The setting circuit 40 sets any one of the internal parameters P_{A}[1] through P_{A}[3] to valid and sets the other two to invalid, on the basis of a setting command signal received by the communication circuit 30 (a setting command signal received from the processor 4). The setting command signal including any one of pieces of the command data D_{A}[1] through D_{A}[3] is as described in the first practical example. In a case where a setting command signal received by the communication circuit 30 includes the command data D_{A}[i], the setting circuit 40 sets the internal parameter P_{A}[i] among the internal parameters P_{A}[1] through P_{A}[3] to valid, and sets the other two to invalid. In the second practical example, i indicates 1, 2, or 3. The setting circuit 40, in a case of having set the internal parameter P_{A}[i] to valid, sets the temperature characteristic for the phase compensation circuit 12 to a temperature characteristic TCA[i] according to the valid internal parameter P_{A}[i]. Temperature characteristics TCA[1] through TCA[3] are mutually different. A method of switching the temperature characteristic of the phase compensation circuit 12 is as described in the first practical example (refer to FIG. 9). In a case where the internal parameter P_{A}[i] is set to valid, the candidate circuit 12[i] is used as the phase compensation circuit 12.

In the second practical example, the temperature characteristic of the candidate circuit 12[i] is designed such that, inter alia, feedback control and response performance for the power supply control apparatus 2 are optimized by using the candidate circuit 12[i] as the phase compensation circuit 12 in a case where the ith type of capacitor is used as the output capacitor C1. Basically, in a case where the ith type of capacitor is used as the output capacitor C1, the candidate circuit 12[i] may be caused to have a temperature characteristic such that an amount of change in the capacitance value of the output capacitor C1 due to temperature is offset.

A designer of the system SYS, in the following manner, determines a setting command that should be transmitted from the processor 4. It is presupposed that the specification of the power supply control apparatus 2 (a data sheet) is disclosed to the designer of the system SYS. The specification of the power supply control apparatus 2 discloses setting specification data 630 as illustrated in FIG. 13. The setting specification data 630 illustrates plots (631 through 633) that indicate the temperature characteristics of the first to third types of capacitors. In addition, the setting specification data 630 indicates information recommending enabling a first setting in a case CS1_EX2 in which the capacitance value of the output capacitor C1 has a temperature characteristic that matches or is similar to the solid line segment 631, information recommending enabling a second setting in a case CS2_EX2 in which the capacitance value of the output capacitor C1 has a temperature characteristic that matches or is similar to the dashed line segment 632, and information recommending enabling a third setting in a case CS3_EX2 in which the capacitance value of the output capacitor C1 has a temperature characteristic that matches or is similar to the dashed curve 633. An ith setting corresponds to a setting for using the candidate circuit 12[i] for the phase compensation circuit 12. In order to enable the ith setting, information to the effect that a setting command signal that includes the command data D_{A}[i] should be transmitted to the power supply control apparatus 2 is also indicated in the specification of the power supply control apparatus 2.

The designer of the system SYS may refer to the specification, which is for the power supply control apparatus 2 and includes the setting specification data 630, and design the processor 4 such that a setting command signal that includes the command data D_{A}[1] for enabling the first setting is transmitted to the power supply control apparatus 2 in the case CS1_EX2, a setting command signal that includes the command data D_{A}[2] for enabling the second setting is transmitted to the power supply control apparatus 2 in the case CS2_EX2, and a setting command signal that includes the command data D_{A}[3] for enabling the third setting is transmitted to the power supply control apparatus 2 in the case CS3_EX2. In this manner, a setting command signal transmitted to the power supply control apparatus 2 includes data (any one of the pieces of command data D_{A}[1] through D_{A}[3]) that corresponds to the temperature characteristic of the output capacitor C1.

When supply of power to the power supply control apparatus 2 is started and the power supply control apparatus 2 activates, an initial sequence operation that handles, inter alia, initialization of internal circuits in the power supply control apparatus 2 is executed. For example, the setting circuit 40 awaits reception of a setting command signal during the initial sequence operation. When a setting command signal is received by the communication circuit 30, the setting circuit 40 sets any one of the internal parameters P_{A}[1] through P_{A}[3] to valid according to the received setting command signal (refer to FIG. 11). Subsequently, switching control is started according to the valid internal parameter.

By virtue of the second practical example, it is possible to use a phase compensation circuit 12 having an optimal temperature characteristic in alignment with the temperature characteristic of the output capacitor C1 that is actually disposed outside the power supply control apparatus 2, and optimization of, inter alia, feedback control and response performance for the power supply control apparatus 2 can be expected. The designer of the power supply control apparatus 2 is different from the designer of the system SYS. The designer of the system SYS purchases the power supply control apparatus 2 from a business entity that manufactures and sells the power supply control apparatus 2, and incorporates the power supply control apparatus 2 in the system SYS. In these circumstances, instead of directly designating the temperature characteristic of the phase compensation circuit 12 through the processor 4, the designer of the system SYS selects which of the first through third settings to enable with reference to the specification of the power supply control apparatus 2. Accordingly, from the standpoint of the business entity that manufactures and sells the power supply control apparatus 2, it is possible to optimize the temperature characteristic of the phase compensation circuit 12 in alignment with each system SYS, in a state where details of the internal structure of the power supply control apparatus 2 are made to be a black box (in other words, with an example in which the details are not disclosed to the designer of the system SYS). Optimization of a transient response characteristic becomes possible due to the optimization of the temperature characteristic. Accordingly, there is a higher possibility of being able to maintain a favorable power conversion operation even if output capacitance (the capacitance of the output capacitor C1) is reduced. In other words, it becomes possible to reduce the output capacitance, and, in a case of using a circuit that connects a plurality of capacitors in parallel to form the output capacitor C1, it also becomes possible to reduce the number of components (reduce the number of capacitors that are connected in parallel).

Note that, in order to simplify the description while providing a more specific description, description has been given for a method of setting the temperature characteristic of the phase compensation circuit 12 to any one of three types after assuming that the three types of capacitors are used as the output capacitor C1. However, the number of types of capacitors used as the output capacitor C1 may be two or more and, in conjunction therewith, the number of types of temperature characteristics for the phase compensation circuit 12 may be two or more.

### THIRD PRACTICAL EXAMPLE

A third practical example is described. The third practical example is a combination of the first and second practical examples. Regarding matters not particularly described in the third practical example, the description in the first or second practical example applies to the third practical example unless there is an inconsistency. In the third practical example, each of the temperature characteristic of the coil L1 and the temperature characteristic of the output capacitor C1 is considered to be varied.

In the third practical example, it is assumed that any one of the first to third types of coils described in the first practical example is selectively used as the coil L1, and any one of the first to third types of capacitors described in the second practical example is selectively used as the output capacitor C1.

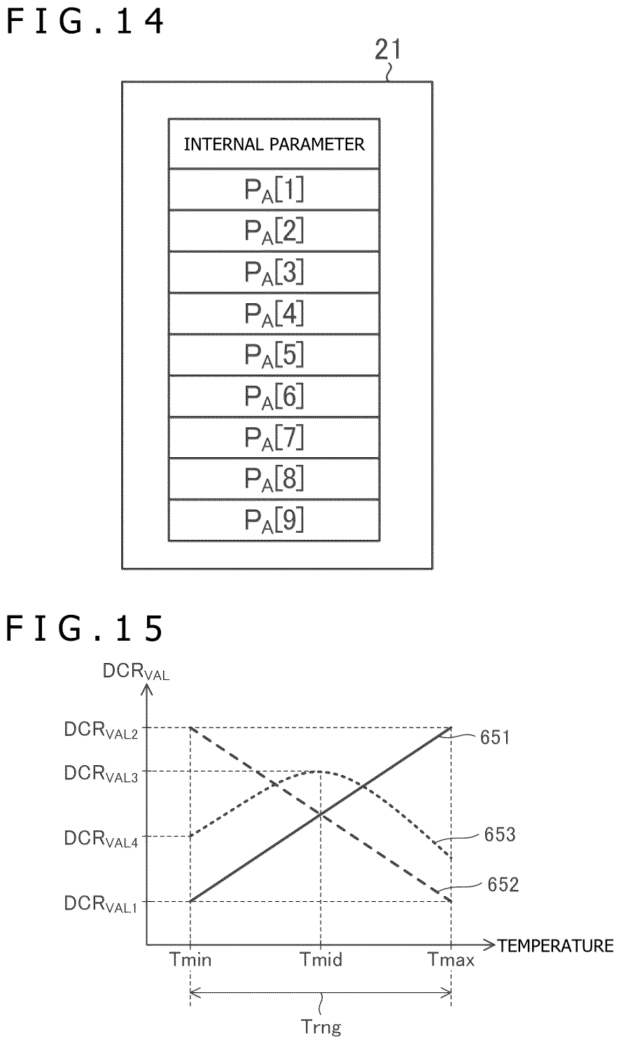

The plurality of internal parameters stored in the parameter storage circuit 21 include internal parameters P_{A}[1] through P_{A}[9] as indicated in FIG. 14. The internal parameters P_{A}[1] through P_{A}[9] each define a temperature characteristic for the phase compensation circuit 12. The setting circuit 40 sets any one of the internal parameters P_{A}[1] through P_{A}[9] to valid and sets the remaining eight internal parameters to invalid, on the basis of a setting command signal received by the communication circuit 30 (a setting command signal received from the processor 4).

The setting command signal received by the communication circuit 30 includes any one piece of command data among pieces of command data D_{A}[1] through D_{A}[9]. Command data D_{A}[i] is data that corresponds to an internal parameter P_{A}[i], and is data for commanding that the internal parameter P_{A}[i] be set to valid. Accordingly, in a case where a setting command signal received by the communication circuit 30 includes the command data D_{A}[i], the setting circuit 40 sets the internal parameter P_{A}[i] among the internal parameters P_{A}[1] through P_{A}[9] to valid, and sets the remaining eight internal parameters to invalid. In the third practical example, i indicates one integer that is equal to or greater than 1 and equal to or less than 9.

The setting circuit 40, in a case of having set the internal parameter P_{A}[i] to valid, sets the temperature characteristic for the phase compensation circuit 12 to a temperature characteristic TCA[i] according to the valid internal parameter P_{A}[i]. Temperature characteristics TCA[1] through TCA[9] are mutually different. In order to realize switching of the temperature characteristic of the phase compensation circuit 12, nine candidate circuits 12[1] through 12[9] having mutually different temperature characteristics are provided in advance in the power supply control apparatus 2 as candidates for the phase compensation circuit 12. The candidate circuits 12[1] through 12[3] are as illustrated in FIG. 9. Illustration of the candidate circuits 12[4] through 12[9] is omitted, but each of the candidate circuits 12[4] through 12[9] has a configuration that is similar to that of the candidate circuit 12[1] (however, the temperature characteristic thereof differs).

It is possible to use the method described in the first practical example (refer to FIG. 9) as a method for causing any one of the candidate circuits 12[1] through 12[9] to selectively function as the phase compensation circuit 12. The candidate circuit 12[i] is a series circuit of a capacitor 12C[i] and a resistor 12R[i], and corresponds to the internal parameter P_{A}[i]. Accordingly, in a case where the internal parameter P_{A}[i] is set to valid, the candidate circuit 12[i] is used as the phase compensation circuit 12, and the capacitor 12C[i] and the resistor 12R[i] function as the capacitor 12C and the resistor 12R in FIG. 4.

The temperature characteristic of the candidate circuit 12[i] is defined by the temperature characteristic of the capacitor 12C[i] and the temperature characteristic of the resistor 12R[i]. The temperature characteristics of the capacitors 12C[1] through 12C[9] are mutually different, and the temperature characteristics of the resistors 12R[1] through 12R[9] are mutually different. As a result, the temperature characteristics of the candidate circuits 12[1] through 12[9] are mutually different. Accordingly, the temperature characteristic of the phase compensation circuit 12 when a candidate circuit 12[p] is used as the phase compensation circuit 12 is mutually different from the temperature characteristic of the phase compensation circuit 12 when a candidate circuit 12[q] is used as the phase compensation circuit 12 (p and q here represent mutually different integers that are equal to or greater than 1 and equal to or less than 9).

There are nine types of combinations of the first to third types of coils and the first to third types of capacitors. In the third practical example, the temperature characteristics of the candidate circuits 12[1] through 12[9] are designed one-to-one in association with first to ninth types of combinations. In other words, the temperature characteristic of a candidate circuit 12[i_{A}] is designed such that, inter alia, feedback control and response performance for the power supply control apparatus 2 are optimized by using the candidate circuit 12[i_{A}] as the phase compensation circuit 12 in a case where the i_{A}th type of coil is used as the coil L1 and the first type of capacitor is used as the output capacitor C1. Here, i_{A} represents 1, 2, or 3. The temperature characteristic of a candidate circuit 12[i_{A}+3] is designed such that, inter alia, feedback control and response performance for the power supply control apparatus 2 are optimized by using the candidate circuit 12[1A+3] as the phase compensation circuit 12 in a case where the i_{A}th type of coil is used as the coil L1 and the second type of capacitor is used as the output capacitor C1. The temperature characteristic of a candidate circuit 12[i_{A}+6] is designed such that, inter alia, feedback control and response performance for the power supply control apparatus 2 are optimized by using the candidate circuit 12[1A+6] as the phase compensation circuit 12 in a case where the iAth type of coil is used as the coil L1 and the third type of capacitor is used as the output capacitor C1.

A designer of the system SYS, in the following manner, determines a setting command that should be transmitted from the processor 4. It is presupposed that the specification of the power supply control apparatus 2 (a data sheet) is disclosed to the designer of the system SYS. The specification of the power supply control apparatus 2 describes setting specification data that is provided for a determination (a determination by the designer of the system SYS) of which of first to ninth settings conforms to the temperature characteristics of the coil L1 and the output capacitor C1. The setting specification data includes data that is similar to the setting specification data 610 in FIG. 10 and the setting specification data 630 in FIG. 13. An ith setting corresponds to a setting for using the candidate circuit 12[i] for the phase compensation circuit 12. In order to enable the ith setting, information to the effect that a setting command signal that includes the command data D_{A}[i] should be transmitted to the power supply control apparatus 2 is also indicated in the specification of the power supply control apparatus 2.

The designer of the system SYS may refer to the specification of the power supply control apparatus 2 and design the processor 4 such that a setting command signal that includes any one of pieces of the command data D_{A}[1] through D_{A}[9] is transmitted to the power supply control apparatus 2, according to the respective temperature characteristics of the coil L1 and the output capacitor C1. In this manner, a setting command signal transmitted to the power supply control apparatus 2 includes data (any one of pieces of the command data D_{A}[1] through D_{A}[9]) that corresponds to the temperature characteristics of the coil L1 and the output capacitor C1.

When supply of power to the power supply control apparatus 2 is started and the power supply control apparatus 2 activates, an initial sequence operation that handles, inter alia, initialization of internal circuits in the power supply control apparatus 2 is executed. For example, the setting circuit 40 awaits reception of a setting command signal during the initial sequence operation. When a setting command signal is received by the communication circuit 30, the setting circuit 40 sets any one of the internal parameters P_{A}[1] through P_{A}[9] to valid according to the received setting command signal. Subsequently, switching control is started according to the valid internal parameter.

By virtue of the third practical example, it is possible to achieve the actions and effects described in the first practical example, as well as the actions and effects described in the second practical example.

Note that, in order to simplify the description while providing a more specific description, description has been given for a method of setting the temperature characteristic of the phase compensation circuit 12 to any one of nine types after assuming that three types of coils are used as the coil L1 and three types of capacitors are used as the output capacitor C1. However, the number of types of coils used as the coil L1 may be two or more, and the number of types of capacitors used as the output capacitor C1 may be two or more. The number of types of temperature characteristics for the phase compensation circuit 12 may be two or more.

### FOURTH PRACTICAL EXAMPLE

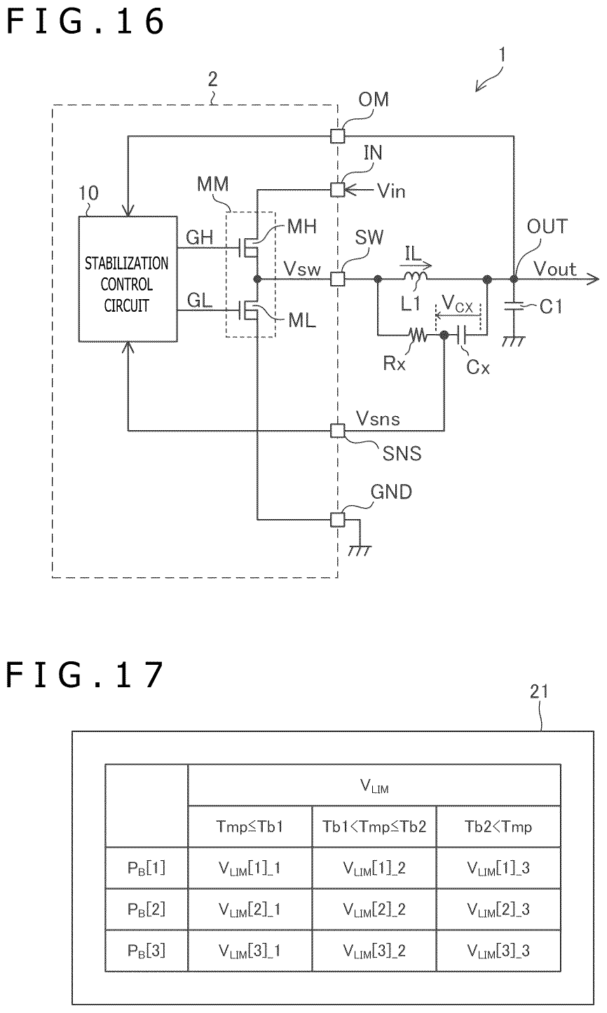

A fourth practical example is described. The fourth practical example may be implemented in combination with the first, second, or third practical example. FIG. 15 illustrates the temperature characteristics of the series resistance value of each of first to third types of coils. The series resistance value is represented by the reference symbol “DCR_{VAL}.” In FIG. 15, a solid line segment 651 represents the temperature characteristic of the series resistance value DCR_{VAL} for the first type of coil, a dashed line segment 652 represents the temperature characteristic of the series resistance value DCR_{VAL} for the second type of coil, and a dashed curve 653 represents the temperature characteristic of the series resistance value DCR_{VAL} for the third type of coil. The relation between the temperatures Tmin, Tmid, and Tmax and the temperature range Trng is as described above.

In order to provide a more specific description, it is assumed that the first to third types of coils have the following temperature characteristics. Series resistance values DCR_{VAL1} through DCR_{VAL4} illustrated in FIG. 15 satisfy a relation “DCR_{VAL1}<DCR_{VAL4}<DCR_{VAL}3<DCR_{VAL2}.” As indicated by the solid line segment 651, the series resistance value DCR_{VAL} for the first type of coil is the series resistance value DCR_{VAL1} when the temperature of the first type of coil matches the minimum temperature Tmin, and is the series resistance value DCR_{VAL2} when the temperature of the first type of coil matches the maximum temperature Tmax. The series resistance value DCR_{VAL} for the first type of coil monotonically increases as the temperature of the first type of coil rises from the minimum temperature Tmin to the maximum temperature Tmax. As indicated by the dashed line segment 652, the series resistance value DCR_{VAL} for the second type of coil is the series resistance value DCR_{VAL2} when the temperature of the second type of coil matches the minimum temperature Tmin, and is the series resistance value DCR_{VAL1} when the temperature of the second type of coil matches the maximum temperature Tmax. The series resistance value DCR_{VAL} for the second type of coil monotonically decreases as the temperature of the second type of coil rises from the minimum temperature Tmin to the maximum temperature Tmax.

As indicated by the dashed curve 653, the series resistance value DCR_{VAL} for the third type of coil is the series resistance value DCR_{VAL4} when the temperature of the third type of coil matches the minimum temperature Tmin, and is the series resistance value DCR_{VAL3} when the temperature of the third type of coil matches the intermediate temperature Tmid. The series resistance value DCR_{VAL} for the third type of coil monotonically increases as the temperature of the third type of coil rises from the minimum temperature Tmin to the intermediate temperature Tmid, and the series resistance value DCR_{VAL} for the third type of coil monotonically decreases as the temperature of the third type of coil rises from the intermediate temperature Tmid to the maximum temperature Tmax. When the temperature of the third type of coil matches the maximum temperature Tmax, the series resistance value DCR_{VAL} for the third type of coil is less than the series resistance value DCR_{VAL3} and greater than the series resistance value DCR_{VAL1}.

In the on time period for the transistor MH, the coil current IL flows from the input terminal IN to the output terminal OUT, and the coil L1 is inserted into the flow path for the coil current IL. When the coil current IL flows through the coil L1, the sum of the counter-electromotive force produced by an inductance component of the coil L1 and a voltage drop produced by a series resistance component of the coil L1 is applied across both ends of the coil L1. The power supply control apparatus 2 according to the fourth practical example has a function of detecting the voltage drop produced by the series resistance component of the coil L1, and can use this function to perform the overcurrent protection operation.

FIG. 16 is a partial block diagram of the power supply apparatus 1 according to the fourth practical example. A detection resistor Rx and a detection capacitor Cx are added to the discrete component group 3 (refer to FIG. 1) in the fourth practical example. A sense terminal SNS is added, as an external terminal, to the power supply control apparatus 2 according to the fourth practical example. The detection resistor Rx and the detection capacitor Cx are connected in series to each other, and the series circuit of the detection resistor Rx and the detection capacitor Cx is connected in parallel to the coil L1. More specifically, a first end of the detection resistor Rx is connected to the switch terminal SW and is also connected to the first end of the coil L1. A second end of the detection resistor Rx is connected to a first end of the detection capacitor Cx. The second end of the detection resistor Rx and the first end of the detection capacitor Cx are both connected to the sense terminal SNS. A second end of the detection capacitor Cx is connected to the second end of the coil L1 and is also connected to the output terminal OUT.

The voltage at the sense terminal SNS is referred to as a sense voltage Vsns. The voltage across both ends of the detection capacitor Cx is referred to as a voltage V_{CX}. The voltage V_{CX} is represented by a relation “Voltage V_{CX}=Vsns−Vout.” A signal component of the voltage across both ends of the coil L1 is configured by an alternating-current component and a direct-current component, and the direct-current component among these is represented by the product of a series resistance component DCR_{L1} of the coil L1 and the coil current IL (DCR_{L1}×IL). Considering only the direct-current component of a signal produced by the circuit formed from the coil L1, the detection resistor Rx, and the detection capacitor Cx, it is widely known that a relation “DCR_{L1}×IL=V_{CX}” is satisfied (it is possible to set the time constant of the detection resistor Rx and the detection capacitor Cx such that the relation “DCRL1× IL=V_{CX}” holds true) and that it is possible to detect the coil current IL or a direct-current resistance component DCR_{L1} of the coil L1 (in other words, the direct-current resistance value of the coil L1) from the voltage V_{CX} (for example, Non-Patent Literature: “Comparison of DCR Current Sense Topologies,” [online], RICHTEK,[retrieved on Aug. 9, 2024], internet <URL: https://www.richtek.com/Design % 20Support/Technical %20Document/AN037?sc_lang=en>).

The stabilization control circuit 10 is connected to the output monitoring terminal OM and thus receives the output voltage Vout, while being connected to the sense terminal SNS and thus receiving the sense voltage Vsns. The stabilization control circuit 10 can detect and identify the voltage V_{CX} on the basis of the output voltage Vout and the sense voltage Vsns, and perform an overcurrent protection operation based on the voltage V_{CX}.

The stabilization control circuit 10 compares the voltage V_{CX} with a threshold voltage V_{LIM} in a time period in which the output stage MM is set to the high-output state according to the rising edge of the signal SET and, upon detecting that the voltage V_{CX} is equal to or greater than the threshold voltage V_{LIM}, performs a protection operation for immediately switching the output stage MM from the high-output state to the low-output state, regardless of the level of the signal RST. This protection operation is an overcurrent protection operation, and, due to the overcurrent protection operation, the voltage V_{CX} is limited to be equal to or less than the threshold voltage V_{LIM} when the positive coil current IL is flowing. The voltage V_{CX} is limited to be less than or equal to the threshold voltage V_{LIM}, whereby the magnitude of the coil current IL can be limited to be equal to or less than a constant threshold current (V_{CX}/DCR_{L1}) if it is supposed that the direct-current resistance value of the coil L1 (in other words, the direct-current resistance component DCR_{L1}) is constant.

It is ideal for the transistor MH to be switched from on to off due to the overcurrent protection operation functioning at the point in time when the magnitude of the coil current IL has reached the constant threshold current. However, the direct-current resistance value of the coil L1 fluctuates due to temperature, and the temperature characteristic of the direct-current resistance value of the coil L1 is varied due to the type of the coil L1 (refer to FIG. 15). If it is possible to dynamically adjust the threshold voltage V_{LIM} in consideration of the temperature characteristic of the direct-current resistance value of the coil L1, optimizing the overcurrent protection operation for any temperature can be addressed.

Considering this, in the fourth practical example, the power supply control apparatus 2 is configured such that it becomes possible to switch between, as the temperature characteristic of the stabilization control circuit 10, a plurality of temperature characteristics for the threshold voltage V_{LIM} in the overcurrent protection operation. The plurality of internal parameters stored in the parameter storage circuit 21 include internal parameters P_{B}[1] through P_{B}[3] that are illustrated in FIG. 17. The internal parameters P_{B}[1] through P_{B}[3] each define a temperature characteristic of the threshold voltage V_{LIM}. The setting circuit 40 sets any one of the internal parameters P_{B}[1] through P_{B}[3] to valid and sets the other two to invalid, on the basis of a setting command signal received by the communication circuit 30 (a setting command signal received from the processor 4).

The setting command signal received by the communication circuit 30 includes one piece of command data among pieces of command data D_{B}[1] through D_{B}[3]. Command data D_{B}[i] is data that corresponds to an internal parameter P_{B}[i], and is data for commanding that the internal parameter P_{B}[i] be set to valid. Accordingly, in a case where a setting command signal received by the communication circuit 30 includes the command data D_{B}[i], the setting circuit 40 sets the internal parameter P_{B}[i] among the internal parameters P_{B}[1] through P_{B}[3] to valid, and sets the other two to invalid. In the fourth practical example, i indicates 1, 2, or 3.

The setting circuit 40, in a case of having set the internal parameter P_{B}[i] to valid, sets the temperature characteristic of the threshold voltage V_{LIM} to the temperature characteristic TCB[i] according to the valid internal parameter P_{B}[i]. Temperature characteristics TCB[1] through TCB[3] are mutually different. The temperature detection circuit 5 (refer to FIG. 3) according to the fourth practical example detects the temperature of the coil L1 as the temperature Tmp, and supplies the temperature detection signal Tsns, which specifies the temperature Tmp, to the setting circuit 40.

Three candidate threshold voltages are defined for each of the internal parameters P_{B}[1] through P_{B}[3]. The three candidate threshold voltages defined by the internal parameter P_{B}[i] are candidate threshold voltages V_{LIM}[i] _1, V_{LIM}[i]_2, and V_{LIM}[i] _3. Each candidate threshold voltage is a candidate for the threshold voltage V_{LIM}. Temperatures Tb1 and Tb2 are two boundary temperatures that satisfy a relation “Tmin<Tb1<Tb2<Tmax.” The internal parameter P_{B}[i] prescribes the threshold voltage V_{LIM} such that a relation “V_{LIM}=V_{LIM}[i] _1” when a relation “Tmp≤ Tb1” holds true, a relation “V_{LIM}=V_{LIM}[i] _2” when a relation “Tb1<Tmp≤Tb2” holds true, and a relation “V_{LIM}=V_{LIM}[i] _3” when a relation “Tb2<Tmp” holds true. Therefore, in a case where the internal parameter P_{B}[i] is set to valid, the setting circuit 40 dynamically sets the threshold voltage V_{LIM} on the basis of the temperature detection signal Tsns such that a relation “V_{LIM}=V_{LIM}[i] _1” is satisfied when a relation “Tmp≤Tb1” holds true, a relation “V_{LIM}=V_{LIM}[i] _2” is satisfied when a relation “Tb1<Tmp≤Tb2” holds true, and a relation “V_{LIM}=V_{LIM}[i] 3” is satisfied when a relation “Tb2<Tmp” holds true. Each candidate threshold voltage is predetermined in advance, aiming at the transistor MH being switched from on to off owing to the overcurrent protection operation functioning at the point in time when the magnitude of the coil current IL has reached the constant threshold current (V_{CX}/DCR_{L1}).

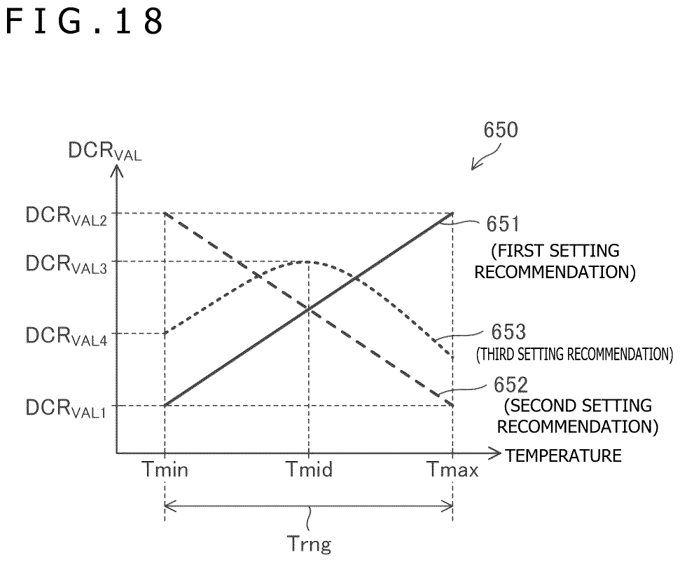

A designer of the system SYS, in the following manner, determines a setting command that should be transmitted from the processor 4. It is presupposed that the specification of the power supply control apparatus 2 (a data sheet) is disclosed to the designer of the system SYS. The specification of the power supply control apparatus 2 discloses setting specification data 650 as illustrated in FIG. 18. The setting specification data 650 illustrates plots (651 through 653) that indicate the temperature characteristics of the direct-current resistance value of the first to third types of coils. In addition, the setting specification data 650 indicates information recommending enabling a first setting in a case CS1_EX4 in which the direct-current resistance value of the coil L1 has a temperature characteristic that matches or is similar to the solid line segment 651, information recommending enabling a second setting in a case CS2_EX4 in which the direct-current resistance value of the coil L1 has a temperature characteristic that matches or is similar to the dashed line segment 652, and information recommending enabling a third setting in a case CS3_EX4 in which the direct-current resistance value of the coil L1 has a temperature characteristic that matches or is similar to the dashed curve 653. The ith setting corresponds to a setting for the threshold voltage V_{LIM} according to the internal parameter P_{B}[i]. In order to enable the ith setting, information to the effect that a setting command signal that includes the command data D_{B}[i] should be transmitted to the power supply control apparatus 2 is also indicated in the specification of the power supply control apparatus 2.

The designer of the system SYS may refer to the specification, which is for the power supply control apparatus 2 and includes the setting specification data 650, and design the processor 4 such that a setting command signal that includes the command data D_{B}[1] for enabling the first setting is transmitted to the power supply control apparatus 2 in the case CS1_EX4, a setting command signal that includes the command data D_{B}[2] for enabling the second setting is transmitted to the power supply control apparatus 2 in the case CS2_EX4, and a setting command signal that includes the command data D_{B}[3] for enabling the third setting is transmitted to the power supply control apparatus 2 in the case CS3 EX4.

For example, a case where the coil L1 is the first type of coil that corresponds to the solid line segment 651 corresponds to the case CS1_EX4, and a relation “V_{LIM}[1] _1<V_{LIM}[1] _2<V_{LIM}[1] _3” is set in the internal parameter P_{B}[1] that is set to valid in this case (CS1_EX4). In another example, a case where the coil L1 is the second type of coil that corresponds to the dashed line segment 652 corresponds to the case CS2_EX4, and a relation “V_{LIM}[2] _1>V_{LIM}[2] _2>V_{LIM}[2] _3” is set in the internal parameter P_{B}[2] that is set to valid in this case (CS2_EX4).

When supply of power to the power supply control apparatus 2 is started and the power supply control apparatus 2 activates, an initial sequence operation that handles, inter alia, initialization of internal circuits in the power supply control apparatus 2 is executed. For example, the setting circuit 40 awaits reception of a setting command signal during the initial sequence operation. When a setting command signal is received by the communication circuit 30, the setting circuit 40 sets any one of the internal parameters P_{B}[1] through P_{B}[3] to valid according to the received setting command signal. Subsequently, switching control is started in a state according to the valid internal parameter.

By virtue of the fourth practical example, it is possible to perform an optimal overcurrent protection operation in alignment with the temperature characteristic of the coil L1 that is actually disposed outside the power supply control apparatus 2. The designer of the power supply control apparatus 2 is different from the designer of the system SYS. The designer of the system SYS purchases the power supply control apparatus 2 from a business entity that manufactures and sells the power supply control apparatus 2, and incorporates the power supply control apparatus 2 in the system SYS. In these circumstances, instead of directly designating the temperature characteristic of the overcurrent protection operation (the temperature characteristic of the threshold voltage V_{LIM}) through the processor 4, the designer of the system SYS selects which of the first through third settings to enable with reference to the specification of the power supply control apparatus 2. Accordingly, from the standpoint of the business entity that manufactures and sells the power supply control apparatus 2, it is possible to optimize the temperature characteristic of the overcurrent protection operation (the temperature characteristic of the threshold voltage V_{LIM}) in alignment with each system SYS, in a state where details of the internal structure of the power supply control apparatus 2 are made to be a black box (in other words, with an example in which the details are not disclosed to the designer of the system SYS).

Note that, in order to simplify the description while providing a more specific description, description has been given for a method of setting the temperature characteristic of the threshold voltage V_{LIM} to one of three types after assuming that three types of coils are used as the coil L1. However, the number of types of coils used as the coil L1 may be two or more and, in conjunction therewith, the number of types of temperature characteristics for the threshold voltage V_{LIM} may be two or more. In addition, in the example in FIG. 17, three temperature ranges are defined through the definitions of the two boundary temperatures Tb1 and Tb2, and the threshold voltage V_{LIM} is dynamically set according to which of the three temperature ranges the temperature Tmp belongs to, but the threshold voltage V_{LIM} may dynamically be set according to which of two temperature ranges the temperature Tmp belongs to, or the threshold voltage V_{LIM} may dynamically be set according to which of four or more temperature ranges the temperature Tmp belongs to.

### <<Fifth Practical Example>>

A fifth practical example is described. In the fifth practical example, description is given for applied techniques, modified techniques, supplemental matters, or other techniques, with respect to the matters described above.

The system SYS in FIG. 1 can be mounted to any electrical device. The electrical device may be electrical equipment that is mounted in a vehicle such as an automobile, may be a computer apparatus, or may be a home appliance device or an industrial device.

The relation between high level and low level for any signal or voltage can be set to the reverse of that described above in a manner that does not impair the gist described above.

The types of channels in FETs (field-effect transistors) indicated in the embodiment described above are examples. The type of any FET channel can be changed from P-channel to N-channel or vice-versa, in a manner that does not impair the gist described above.

Unless an inconvenience arises, any transistor described above may be any type of transistor. For example, a discretionary transistor described above as a MOSFET can be replaced by a junction FET, an insulated gate bipolar transistor (IGBT), or a bipolar transistor, unless an inconvenience arises. A discretionary transistor has a first electrode, a second electrode, and a control electrode. In a FET, one of the first and second electrodes is the drain, the other is the source, and the control electrode is the gate. In an IGBT, one of the first and second electrodes is the collector, the other is the emitter, and the control electrode is the gate. In a bipolar transistor that does not belong to an IGBT, one of the first and second electrodes is the collector, the other is the emitter, and the control electrode is the base.

Various modifications can be made, as appropriate, to the embodiment of the present disclosure, without departing from the technical concepts described in the claims. The above embodiment is purely an example of an embodiment of the present disclosure, and the meaning of terms in the present disclosure and constituent features is not limited to that described in the above embodiment. Specific numerical values indicated in the description above are merely examples, and of course can be changed to various other numerical values.

### <<Notes>>

Notes are provided for the present disclosure for which an example of a specific configuration is described in the above-described embodiment.

A power supply control apparatus according to one example of the present disclosure is a power supply control apparatus (2) including an output stage (MM) provided between an input terminal (IN) to which an input voltage (Vin) is applied and an output terminal (OUT) to which an output voltage (Vout) is applied and being configured to generate the output voltage from the input voltage, the power supply control apparatus including a stabilization control circuit (10) configured to cause the output voltage to stabilize to a target voltage (Vtg) by controlling a state of the output stage according to a feedback voltage (Vfb) that corresponds to the output voltage, a parameter storage circuit (21) configured to store a plurality of internal parameters for defining a temperature characteristic of the stabilization control circuit, a communication circuit (30) configured to receive a command signal from an external apparatus (4) that is outside the power supply control apparatus, and a setting circuit (40) configured to set the temperature characteristic of the stabilization control circuit by setting any one of the plurality of internal parameters to valid on the basis of the command signal (a first configuration).

Thus, for example, it is possible to set an appropriate internal parameter to valid by transmitting and receiving a command signal according to the temperature characteristic of the external circuit element that is provided outside the power supply control apparatus. As a result, for example, it becomes possible to appropriately set a temperature characteristic for the stabilization control circuit in alignment with the temperature characteristic of the external circuit element.

In the power supply control apparatus according to the first configuration, it may be configured that the stabilization control circuit controls the state of the output stage such that the error between the feedback voltage and a predetermined reference voltage decreases on the basis of an internal signal (Verr) that corresponds to the error, the stabilization control circuit has a phase compensation circuit (12) configured to compensate for a phase of the internal signal, and the setting circuit sets a temperature characteristic of the phase compensation circuit by setting any one of the plurality of internal parameters to valid on the basis of the command signal (a second configuration).

In the power supply control apparatus according to the second configuration, it may be configured that the plurality of internal parameters include a first internal parameter (P_{A}[1]) and a second internal parameter (P_{A}[2]) that are mutually different, in a case where the command signal received by the communication circuit includes a first piece of data (D_{A}[1]), the setting circuit sets the temperature characteristic of the phase compensation circuit to a first temperature characteristic by setting the first internal parameter that corresponds to the first piece of data to valid, and in a case where the command signal received by the communication circuit includes a second piece of data (D_{A}[2]), the setting circuit sets the temperature characteristic of the phase compensation circuit to a second temperature characteristic different from the first temperature characteristic by setting the second internal parameter that corresponds to the second piece of data to valid (a third configuration).

In the power supply control apparatus according to the second or third configuration, it may be configured that the stabilization control circuit has, as candidates for the phase compensation circuit, a plurality of candidate circuits (including at least 12 [1] and 12[2]) having mutually different temperature characteristics, and by any one of the plurality of internal parameters being set to valid on the basis of the command signal, a candidate circuit that corresponds to the internal parameter set to valid, among the plurality of candidate circuits, is used as the phase compensation circuit (a fourth configuration).

In the power supply control apparatus according to the first configuration, it may be configured that the power supply apparatus includes a coil (L1) that is inserted into a flow path for a current from the input terminal that goes toward the output terminal and a series circuit of a detection resistor (Rx) and a detection capacitor (Cx) is connected in parallel to the coil, the stabilization control circuit executes an overcurrent protection operation for limiting the voltage across both ends of the detection capacitor when the current flows to be less than or equal to a threshold voltage (V_{LIM}), and the setting circuit sets a temperature characteristic for the threshold voltage by setting any one of the plurality of internal parameters to valid on the basis of the command signal (a fifth configuration).

In the power supply control apparatus according to the fifth configuration, it may be configured that the plurality of internal parameters include a first internal parameter (P_{B}[1]) and a second internal parameter (P_{B}[2]) that are mutually different, in a case where the command signal received by the communication circuit includes a first piece of data (D_{B}[1]), the setting circuit sets the temperature characteristic for the threshold voltage to a first temperature characteristic by setting the first internal parameter that corresponds to the first piece of data to valid, and in a case where the command signal received by the communication circuit includes a second piece of data (D_{B}[2]), the setting circuit sets the temperature characteristic for the threshold voltage to a second temperature characteristic different from the first temperature characteristic by setting the second internal parameter that corresponds to the second piece of data to valid (a sixth configuration).

In the power supply control apparatus according to the fifth or sixth configuration, it may be configured that the stabilization control circuit, on the basis of an internal parameter set to valid, causes the threshold voltage to change according to the temperature of the coil (a seventh configuration).

In the power supply control apparatus according to any one of the first to seventh configurations, it may be configured that the output stage has an output transistor (MH), and a state of the output transistor is controlled by the stabilization control circuit (an eighth configuration).

In the power supply control apparatus according to any one of the first to eighth configurations, it may be configured that the command signal has data that corresponds to a temperature characteristic of an external circuit element (L1, C1) that is inside a circuit connected to the output stage outside the power supply control apparatus, the external circuit element being configured to convert the input voltage to the output voltage in collaboration with the stabilization control circuit and the output stage (a ninth configuration).

Thus, it is possible to set an appropriate internal parameter to valid by transmitting and receiving a command signal according to the temperature characteristic of the external circuit element that is provided outside the power supply control apparatus. As a result, it becomes possible to appropriately set a temperature characteristic for the stabilization control circuit in alignment with the temperature characteristic of the external circuit element.

A power supply system (SYS) according to one example of the present disclosure includes a power supply control apparatus (2) according to any one of the first through eighth configurations, an external circuit element (L1, C1) that is inside a circuit connected to the output stage outside the power supply control apparatus, the external circuit element being configured to convert the input voltage to the output voltage in collaboration with the stabilization control circuit and the output stage, and the external apparatus (4) that includes, in the command signal, data that corresponds to a temperature characteristic of the external circuit element (a tenth configuration).

Thus, it is possible to set an appropriate internal parameter to valid by transmitting and receiving a command signal according to the temperature characteristic of the external circuit element that is provided outside the power supply control apparatus. As a result, it becomes possible to appropriately set a temperature characteristic for the stabilization control circuit in alignment with the temperature characteristic of the external circuit element.

What is claimed is:

1. A power supply control apparatus including an output stage provided between an input terminal to which an input voltage is applied and an output terminal to which an output voltage is applied and being configured to generate the output voltage from the input voltage, the power supply control apparatus comprising:
a stabilization control circuit configured to cause the output voltage to stabilize to a target voltage by controlling a state of the output stage according to a feedback voltage that corresponds to the output voltage;
a parameter storage circuit configured to store a plurality of internal parameters for defining a temperature characteristic of the stabilization control circuit;
a communication circuit configured to receive a command signal from an external apparatus that is outside the power supply control apparatus; and
a setting circuit configured to set the temperature characteristic of the stabilization control circuit by setting any one of the plurality of internal parameters to valid on a basis of the command signal.

2. The power supply control apparatus according to claim 1, wherein
the stabilization control circuit controls the state of the output stage such that an error between the feedback voltage and a predetermined reference voltage decreases on a basis of an internal signal that corresponds to the error,
the stabilization control circuit has a phase compensation circuit configured to compensate for a phase of the internal signal, and
the setting circuit sets a temperature characteristic of the phase compensation circuit by setting any one of the plurality of internal parameters to valid on the basis of the command signal.

3. The power supply control apparatus according to claim 2, wherein
the plurality of internal parameters include a first internal parameter and a second internal parameter that are mutually different,
in a case where the command signal received by the communication circuit includes a first piece of data, the setting circuit sets the temperature characteristic of the phase compensation circuit to a first temperature characteristic by setting the first internal parameter that corresponds to the first piece of data to valid, and,
in a case where the command signal received by the communication circuit includes a second piece of data, the setting circuit sets the temperature characteristic of the phase compensation circuit to a second temperature characteristic different from the first temperature characteristic by setting the second internal parameter that corresponds to the second piece of data to valid.

4. The power supply control apparatus according to claim 2, wherein
the stabilization control circuit has, as candidates for the phase compensation circuit, a plurality of candidate circuits having mutually different temperature characteristics, and
by any one of the plurality of internal parameters being set to valid on the basis of the command signal, a candidate circuit that corresponds to the internal parameter set to valid, among the plurality of candidate circuits, is used as the phase compensation circuit.

5. The power supply control apparatus according to claim 1, wherein
the power supply apparatus includes a coil that is inserted into a flow path for a current from the input terminal that goes toward the output terminal, and a series circuit of a detection resistor and a detection capacitor is connected in parallel to the coil,
the stabilization control circuit executes an overcurrent protection operation for limiting the voltage across both ends of the detection capacitor when the current flows to be less than or equal to a threshold voltage, and
the setting circuit sets a temperature characteristic for the threshold voltage by setting any one of the plurality of internal parameters to valid on the basis of the command signal.

6. The power supply control apparatus according to claim 5, wherein
the plurality of internal parameters include a first internal parameter and a second internal parameter that are mutually different,
in a case where the command signal received by the communication circuit includes a first piece of data, the setting circuit sets the temperature characteristic for the threshold voltage to a first temperature characteristic by setting the first internal parameter that corresponds to the first piece of data to valid, and
in a case where the command signal received by the communication circuit includes a second piece of data, the setting circuit sets the temperature characteristic for the threshold voltage to a second temperature characteristic different from the first temperature characteristic by setting the second internal parameter that corresponds to the second piece of data to valid.

7. The power supply control apparatus according to claim 5, wherein
the stabilization control circuit, on a basis of an internal parameter set to valid, causes the threshold voltage to change according to the temperature of the coil.

8. The power supply control apparatus according to claim 1, wherein
the output stage has an output transistor, a state of the output transistor being controlled by the stabilization control circuit.

9. The power supply control apparatus according to claim 1, wherein
the command signal has data that corresponds to a temperature characteristic of an external circuit element that is inside a circuit connected to the output stage outside the power supply control apparatus, the external circuit element being configured to convert the input voltage to the output voltage in collaboration with the stabilization control circuit and the output stage.

10. A power supply system comprising:
the power supply control apparatus according to claim 1;
an external circuit element that is inside a circuit connected to the output stage outside the power supply control apparatus, the external circuit element being configured to convert the input voltage to the output voltage in collaboration with the stabilization control circuit and the output stage; and
the external apparatus that includes, in the command signal, data that corresponds to a temperature characteristic of the external circuit element.
